(19) United States
(12) Patent Application Publication
(10) Pub. No.: US 2015/0047903 A1
(43) Pub. Date: Feb. 19, 2015

(54) ANALYSIS OF GEOLOGICAL OBJECTS

(71) Applicant: WESTERNGECO L.L.C., HOUSTON, TX (US)

(72) Inventors: Oddgeir Gramstad, Algard (NO); Jan Øystein Haavig Bakke, Stavanger (NO)

(73) Assignee: Westerngeco LLC, Houston, TX (US)

(21) Appl. No.: 14/386,727

(22) PCT Filed: Mar. 27, 2013
(86) PCT No.: PCT/IB2013/052458

§ 371 Date: Sep. 19, 2014

Related U.S. Application Data
(60) Provisional application No. 61/617,520, filed on Mar. 29, 2012.

(51) Int. Cl. G01V 1/30; E21B 49/00; G01V 1/34

(52) U.S. Cl. CPC G01V 1/30; G01V 1/345; E21B 49/00; G01V 2210/74; G01V 2210/62; G01V 1/40
USPC 175/50; 367/7; 702/14

(57) ABSTRACT

A method of determining a search expression describing a feature of interest in a set of data points distributed throughout a geological object is provided. Each data point contains a value for a geological attribute at that point. The search expression has a plurality of entries. The method including the steps of: (i) displaying the geological object using display codings corresponding to value subranges for the geological attribute such that all data points which have values for the geological attribute falling within a given value subrange are displayed with the same coding; (ii) selecting a plurality of data points of the feature of interest; and (iii) allocating value characters to entries of the search expression, the value characters corresponding to the value subranges for the geological attribute of the selected data points.

### BACKGROUND

This disclosure relates in general to the analysis of geological objects and, more specifically, but not by way of limitation, to the analysis of seismic attributes of geological objects.

The characterisation of subsurface strata is important for identifying, accessing and managing reservoirs. The depths and orientations of such strata can be determined, for example, by seismic surveying. This is generally performed by imparting energy to the earth at one or more source locations, for example, by way of controlled explosion, mechanical input etc. Return energy is then measured at surface receiver locations at varying distances and azimuths from the source location. The travel time of energy from source to receiver, via reflections and refractions from interfaces of subsurface strata, indicates the depth and orientation of the strata.

U.S. Pat. No. 7,248,539 discloses a method for automated extraction of surface primitives from seismic data, the disclosure of which application is incorporated by reference herein for all purposes. For example, one embodiment of the method of U.S. Pat. No. 7,248,539 involves defining, typically with sub-sample precision, positions of seismic horizons through an extrema representation of a 3D seismic input volume; deriving coefficients that represent the shape of the seismic waveform in the vicinity of the extrema positions; sorting the extrema positions into groups that have similar waveform shapes by applying classification techniques with the coefficients as input attributes using unsupervised or supervised classification based on an underlying statistical class model; and extracting surface primitives as surface segments that are both spatially continuous along the extrema of the seismic volume and continuous in class index in the classification volume.

The characterisation of faults and fractures in reservoir formations can also be important. For example, fractures intersecting drilled wells may assist the flow of hydrocarbons from the reservoir and so increase production. Conversely, fractures may allow water to flow into wells and so decrease production.

WO 2008/086352 describes a methodology for mapping fracture networks from seismic data using fracture enhancement attributes and fracture extraction methods. For example, borehole data can be used to determine modes of fracture, and in particular whether fracture clusters or networks would be detectable in surface seismic data. It can also provide information on fracture network inclination (i.e. average inclination of the fractures in a network relative to the horizontal) and strike azimuth (i.e. average direction of intersection of the fractures in a network relative to the horizontal).

Discontinuity extraction software (DES), for example as described in U.S. Pat. No. 7,203,342, may then be utilised to extract 3D volumes of fracture networks from surface seismic data. Extracted fracture networks may be parameterised in terms of the strength of their seismic response, and on their length, height and width.

The approach of U.S. Pat. No. 7,203,342 may also be used to characterise and extract other geological features, such as faults, from seismic data.

However, a problem arises of identifying relevant information in geological volumes which may contain large amounts of seismic and other geological information. Thus WO2011/077300 proposes a method of processing data points distributed throughout a geological volume, each data point being associated with respective geological attributes, such as seismic attributes, geometric attributes or numerical modelling derived attributes. The method includes the steps of: coding the geological attributes of each data point as a respective character string; compiling a query character string defining sought geological attributes of an arrangement (e.g. a line) of one or more data points; searching the coded geological attributes for arrangements of data points having geological attributes matching the query character string; and identifying matched data points. The identified data points can then be graphically displayed. By coding the geological attributes as character strings, large amounts of information can be presented in a format that facilitates fast and efficient searching by the query character string. For example, the graphical display may show surface horizons associated with the identified data points.

### SUMMARY

Accordingly, a first aspect of the present invention provides a computer-implemented method of identifying a feature of interest in a set of data points distributed throughout a geological object, each data point containing a value for a geological attribute at that point, the method including the steps of:
providing a translator which defines a plurality of value subranges for the geological attribute;
displaying the geological object using display codings corresponding to the value subranges such that all data points which have values for the geological attribute falling within a given value subrange are displayed with the same coding;
repeatedly adjusting one or more end values of the value subranges, and redisplaying the geological object using the respective display codings for the adjusted value subranges, until the feature of interest is identifiable in the redisplayed geological object.

The method can include the further step of identifying the feature of interest in the redisplayed geological object. The method can further include the step of displaying the value subranges of the translator as translator GUI elements (e.g. including the display codings), and wherein the adjustment of the one or more end values of the value subranges is performed by adjusting the translator GUI elements.

By displaying and redisplaying the geological object using the (adjusted) value subranges, a user can be facilitated to arrive at a view of the object which allows him to easily identify features of interest in the data points.

The method of the first aspect can further include the step of determining a search expression describing the feature of interest, the search expression having a plurality of entries, wherein the determining step includes performing the steps of:
selecting a plurality of data points of the feature of interest; and
allocating value characters to entries of the search expression, the value characters corresponding to the value subranges for the geological attribute of the selected data points.

By allocating the value characters corresponding to the value subranges for the geological attribute of the selected data points, a user can be enabled to determine a suitable search expression even if he does not have particular expertise in and experience of such expressions.

Indeed, a second aspect of the present invention provides a computer-implemented method of determining a search expression describing a feature of interest in a set of data points distributed throughout a geological object, each data point containing a value for a geological attribute at that point, and the search expression having a plurality of entries, the method including the steps of:
displaying the geological object using display codings corresponding to value subranges for the geological attribute such that all data points which have values for the geological attribute falling within a given value subrange are displayed with the same coding;
selecting a plurality of data points of the feature of interest; and
allocating value characters to entries of the search expression, the value characters corresponding to the value subranges for the geological attribute of the selected data points.

A third aspect of the present invention provides a computer-implemented method of extracting signal consistent surface primitives from a set of data points distributed throughout a geological object, the method including the steps of:
providing a plurality of groups of data points, the data points from each group respectively corresponding to one or more seismic horizons (and the data points typically being placed on local minima and/or maxima of the seismic data);
assigning a respective quality value to each group of data points on the basis of the data points from that group;
placing the groups of data points in a priority queue;
defining one or more surface primitives corresponding to the seismic horizons; and
repeating the sub-steps of:
   selecting from the priority queue the group of data points having the highest quality value and deleting the selected group from the priority queue;
   growing the surface primitives by adding the data points from the selected group to the corresponding surface primitives;
   identifying nearest-neighbour data points to the data points from the selected group, the identified nearest-neighbour data points forming further groups of data points meeting a pre-defined criterion for inclusion in the surface primitives; and
   adding the further groups of data points to the priority queue.

Advantageously the surface primitive extraction method can be fully automated, removing operator bias from the growth of the surface primitives. Further, the method enables correct geological time sorting of the extracted surface primitives. In addition, the method, by focussing on targeted surfaces, can avoid computer memory issues. This can enable lateral growth of the surface primitives up to basin scales.

A fourth aspect of the present invention provides a method of processing seismic data including the steps of:
performing seismic tests to obtain seismic data for a geological volume;
performing the method of any one of the first to third aspects, the set of data points being based on the seismic data or a subset of the seismic data.

A fifth aspect of the present invention provides a method of controlling a well drilling operation including the steps of:
performing the method of the second aspect (optionally including a preliminary step of performing seismic tests to obtain seismic data for a geological volume, the set of data points of the second aspect being based on the seismic data or a subset of the seismic data) to identify features of interest corresponding to matched arrangements of data points;
determining a well trajectory which extends through the geological object taking account of the identified features of interest; and
drilling a well having the specified trajectory.

A sixth aspect of the present invention provides a method of controlling a well drilling operation including the steps of:
performing the method of the third aspect (optionally including a preliminary step of performing seismic tests to obtain seismic data for a geological volume, the set of data points of the third aspect being based on the seismic data or a subset of the seismic data) to extract signal consistent surface primitives corresponding to one or more seismic horizons;
determining a well trajectory which extends through the geological object taking account of the surface primitives; and
drilling a well having the specified trajectory.

Further aspects of the invention provide (i) a computer system, (ii) a computer program product carrying a program, and (iii) a computer program, each for performing the method of any one of the first to third aspects.

For example, a computer system for identifying a feature of interest in a set of data points distributed throughout a geological object, each data point containing a value for a geological attribute at that point, can include:
a computer-readable medium or media which stores the data points; and
a processor(s) configured to:
   (a) provide a translator which defines a plurality of value subranges for the geological attribute,
   (b) control a display unit to display the geological object using display codings corresponding to the value subranges such that all data points which have values for the geological attribute falling within a given value subrange are displayed with the same coding, and
   (c) adjust one or more end values of the value subranges in response to user input, and control the display unit to redisplay the geological object using the respective display codings for the adjusted value subranges. The computer system may also include the display unit controlled by the processor. The processor(s) may also be configured to control the display unit to display the value subranges of the translator as translator GUI elements. The user input to adjust one or more end values of the value subranges can then be performed by the user adjusting the translator GUI elements.

Also for example, a computer system for determining a search expression describing a feature of interest in a set of data points distributed throughout a geological object, each data point containing a value for a geological attribute at that point, and the search expression having a plurality of entries, can include:
a computer-readable medium or media which stores the data points; and
a processor(s) configured to:
   (a) control a display unit to display the geological object using display codings corresponding to value subranges for the geological attribute such that all data points which have values for the geological attribute falling within a given value subrange are displayed with the same coding, and
   (b) in response to user input selecting a plurality of data points of the feature of interest, allocate value characters to entries of the search expression, the value characters corresponding to the value subranges for the geological attribute of the selected data points. The computer system may also include the display unit controlled by the processor. The user input to selecting a plurality of data points of the feature of interest can then be performed by the user making the selection (e.g. by pointing and clicking) on the displayed geological object.

In another example, a computer system for extracting signal consistent surface primitives from a set of data points distributed throughout a geological object can include:
a computer-readable medium or media which stores a plurality of groups of data points, the data points from each group respectively corresponding to one or more seismic horizons; and
a processor(s) configured to:
   (a) assign a respective quality value to each group of data points on the basis of the data points from that group,
   (b) place the groups of data points in a priority queue,
   (c) define one or more surface primitives corresponding to the seismic horizons, and
   (d) repeatedly:
      (i) select from the priority queue the group of data points having the highest quality value and deleting the selected group from the priority queue,
      (ii) grow the surface primitives by adding the data points from the selected group to the corresponding surface primitives,
      (iii) identify nearest-neighbour data points to the data points from the selected group, the identified nearest-neighbour data points forming further groups of data points meeting a pre-defined criterion for inclusion in the surface primitives, and
      (iv) add the further groups of data points to the priority queue.

Further optional features of the invention will now be set out. In particular, these are applicable singly or in any combination with the first or second aspect of the invention, or with any aspect of the invention which uses the first or second aspect.

The display codings can conveniently be colours and/or grey scales.

The step of selecting a plurality of data points can be performed by pointing at data points in the feature of interest.

The geological object can be 1 D, 2D or 3D. Examples of data sets of 1D objects are well logs or seismic traces. Examples of data sets of 2D objects are 2D seismic lines, any attribute derived from 2D seismic lines and in general any image. Examples of data sets of 3D objects are 3D seismic cubes and any attribute derived from 3D seismic cubes.

When the geological object is a 1D object, the allocating step can further include allocating extent characters to the entries of the search expression, each extent character being associated with a respective entry and specifying the vertical extent of the continuous line of data points which share the value subrange of that entry and which include the selected data point of that entry. The allocating step may then also further include allocating additional value and extent characters to further entries of the search expression, each further entry corresponding to a respective gap between adjacent continuous lines, additional value characters of each further entry corresponding to the value subranges for the geological attribute of the data points within the respective gap, and an additional extent character of each further entry specifying the vertical extent of the respective gap.

When the geological object is a 2D object, the allocating step can further include allocating pairs of extent characters to the entries of the search expression, each pair of extent characters being associated with a respective entry and specifying the minimum and maximum vertical extents of the contiguous area of data points which share the value subrange of that entry and which include the selected data point of that entry. The allocating step may then also further include allocating additional value and extent characters to further entries of the search expression, each further entry corresponding to a respective vertical gap between adjacent contiguous areas, additional value characters of each further entry corresponding to the value subranges for the geological attribute of the data points within the respective gap, and a pair of additional extent characters of each further entry specifying the minimum and maximum vertical extents of the respective gap.

When the geological object is a 3D object, the allocating step can further include allocating pairs of extent characters to the entries of the search expression, each pair of extent characters being associated with a respective entry and specifying the minimum and maximum vertical extents of the contiguous volume of data points which share the value subrange of that entry and which include the selected data point of that entry. The allocating step may then also further include allocating additional value and extent characters to further entries of the search expression, each further entry corresponding to a respective vertical gap between adjacent contiguous volumes, additional value characters of each further entry corresponding to the value subranges for the geological attribute of the data points within the respective gap, and a pair of additional extent characters of each further entry specifying the minimum and maximum vertical extents of the respective gap.

The method may further include the step of displaying the value characters of the search expression as search expression GUI elements using the display codings.

The method may further include modifying one or more value characters of the search expression. For example, when the value characters are displayed as search expression GUI elements using the display codings, the modifying may be performed by adjusting the search expression GUI elements. The method may further include modifying one or more extent characters of the search expression. The method may further include adding entries to and/or removing entries from the search expression.

The method may further include the steps of:
searching the set of data points for arrangements of data points having geological attributes matching the search expression; and
identifying matched arrangements of data points. The method may then typically also include redisplaying the geological object (for example, using the display codings, different display codings and/or the original geological attribute) and indicating the positions of the matched arrangements of data points.

In general, each data point may also contain a value for one or more further geological attributes at that point. More particularly, if each data point also contains a value for a second geological attribute at that point, and matched arrangements of data points have been identified (and optionally the geological object has been redisplayed), the method may further include the steps of:
displaying the geological object using second display codings (such as colours and/or grey scales) corresponding to second value subranges for the second geological attribute such that all data points which have values for the second geological attribute falling within a given second value subrange are displayed with the same second coding, and indicating the positions of the matched arrangements of data points; and
determining a second search expression having entries corresponding to the entries of the first search expression but having value characters which correspond to the second value subranges for the second geological attribute of the matched arrangements of data points. The method may then further include the step of displaying the value characters of the second search expression as second search expression GUI elements using the second display codings.

The method may then further include the steps of:
modifying one or more value characters of the second search expression (for example, by adjusting the second search expression GUI elements); and
redisplaying the geological object (for example, using the first display codings, the second display codings, different display codings, and/or an original geological attribute) and indicating the positions of the previously matched arrangements of data points which still match the modified second search expression.

Each data point can also contain a value for one or more additional (typically nondisplayed) geological attributes at that point, and the or each additional geological attribute can have corresponding value subranges. The method can then further include the step of:
determining one or more additional search expressions, the or each additional search expression having entries corresponding to the entries of the first search expression but having value characters which correspond to the value subranges for a respective one of the additional geological attributes according to the matched arrangements of data points.

Having searched the set of data points for arrangements of data points having geological attributes matching the search expression, identified matched arrangements of data points, redisplayed the geological object and indicated the positions of the matched arrangements of data points, it is then possible to extract data points corresponding to one or more geological features of interest. For example, when, in the redisplayed the geological object, the indicated positions of the matched arrangements of data points are at the feature(s) of interest, a method of extracting data points, can include the further steps of:
repeating one or more times the sub-steps of:
   identifying likely regions of the feature(s) of interest without matched arrangements of data points thereat;
   adjusting the search expression to better describe the identified likely regions;
   searching the set of data points for arrangements of data points having geological attributes matching the adjusted search expression;
   identifying matched arrangements of data points; and
   redisplaying the geological object and indicating the positions of the previously matched arrangements of data points and the most recently matched arrangements of data points; and
extracting data points corresponding to the geological features of interest from the matched arrangements. The approach for determining a search expression of the first or second aspect can be used in the adjusting sub-step to derive the adjusted the search expression. In the adjusting sub-step, the translator discussed above can also be adjusted. More particularly, one or more end values of the value subranges defined by the translator can be adjusted and the geological object redisplayed using the respective display codings for the adjusted value subranges. Typically, the features of interest may be seismic horizons. In this case, in the redisplayed geological object, the indicated positions of the matched arrangements of data points will be at the seismic horizon(s).

Further optional features of the invention will now be set out. In particular, these are applicable singly or in any combination with the third aspect of the invention, or with any aspect of the invention which uses the third aspect.

Typically, each data point contains a value or values for one or more geological attributes at that point, and, in the providing step, the data points are extracted from arrangements of data points which match one or more query character strings defining values of geological attribute(s) associated with one or more seismic horizons in the geological object, the extracted data points from each matched arrangement forming a respective group and within each group respectively corresponding to the seismic horizons.

For example, the extracted data points can be identified by performing the method of WO 2011/077300. According to one option, the providing step may then include: coding the geological attributes of each data point as a respective character string, compiling a query character string defining sought geological attributes of an arrangement of one or more data points, searching the coded seismic attributes for arrangements of data points having geological attributes matching the query character string, identifying the matched data points, and extracting data points corresponding to the seismic horizon(s) from the identified data points.

According to another option, the providing step may include performing the method of the second aspect to identify matched arrangements of data points, the search expression(s) being query character string(s), and extracting data points corresponding to the seismic horizon(s) from the identified arrangements of data points, In particular, this option pertains when the method of the second aspect further includes the steps of: searching the set of data points for arrangements of data points having geological attributes matching the search expression; and identifying matched arrangements of data points.

According to another option, the providing step may include performing the method of the second aspect to extract data point corresponding to the seismic horizon(s). In particular, this option pertains when the method of the second aspect pertains to extracting data points corresponding to one or more geological features of interest.

Typically, the data points may be placed on the minima and/or maxima (i.e. the extrema) of seismic events, as described in U.S. Pat. No. 7,248,539.

Generally each group of data points contains a plurality of data points, e.g. arranged in a vertical line. However, optionally, each group may be a single data point which corresponds to a respective seismic horizon.

Accordingly, an example of the method of third aspect is a computer-implemented method of extracting a signal consistent surface primitive from a set of data points distributed throughout a geological object, the method including the steps of:
providing a plurality of data points corresponding to a seismic horizon;
assigning a respective quality value to each data point;
placing the data points in a priority queue;
defining a surface primitive corresponding to the seismic horizon; and
repeatedly:
   selecting from the priority queue the data point having the highest quality value and deleting the selected data point from the priority queue;
   growing the surface primitive by adding the selected data point to the surface primitive;
   identifying nearest-neighbour data points to the selected data point, the identified nearest-neighbour data points meeting a pre-defined criterion for inclusion in the surface primitive; and
   adding the identified nearest-neighbour data points to the priority queue.

In this example, each data point typically contains a value or values for one or more geological attributes at that point, and, in the providing step, the data points are extracted from arrangements of data points which match one or more query character strings defining values of geological attribute(s) associated with a seismic horizon in the geological object, the extracted data points corresponding to the seismic horizon.

The repeating of the selecting, growing, identifying and adding sub-steps can be performed until the priority queue is empty. The quality value can typically consist of a collection or a combination of different seismic waveform attributes. These attributes can be separated in two main groups: surface attributes and boundary attributes. The surface attributes can specify in which order the groups of data points are selected. One example is to select the group of data points according to the seismic amplitude in a decreasing order, high amplitudes usually corresponding to strong and continuous seismic signal, while low amplitude usually corresponding to noisy and discontinuous seismic signal. Groups of data points with the highest amplitude values will then be added to the surface primitive first, while groups of data points with low amplitude values will be added last. The regions that are already part of the growing surface primitive are continuously used to restrict the growing through the remaining weaker zones. Particularly in challenging seismic data sets, it can be desirable to combine the seismic amplitude in the quality value with other surface attributes, such as horizontal dip, chaos attributes, curvature, gradient trend, etc. When each group of data points contains a plurality of data points, the respective attributes can be average attributes for the group. The boundary attributes are used to constrain the surface growing laterally. Some examples of such attributes are a fault set, an AntTrack cube (see U.S. Pat. No. 7,203,342), a set of horizons, and a set of termination points.

The pre-defined criterion for inclusion of the further groups of data points in the surface primitive can include, for example, any one or more of the following:
Particularly when the groups of data points are single data points or vertical lines of data points, a requirement can be set for the polarities of the nearest-neighbour data points to be the same as those of the corresponding selected data points. This can then avoid the connection of a positive seismic event to a negative seismic event or vice versa.
Particularly when the groups of data points are single data points or vertical lines of data points, a limit can be set on the maximum vertical jump between a data point of the selected group and a corresponding data point of a neighbouring group, for example by default this limit can be equal to the spatial sampling precision of the original seismic data. In addition, when each group of data points contains a plurality of data points, there can be a check which does not allow the growing surface primitives to cross over each other in the vertical direction.
Particularly when the groups of data points are vertical lines of data points, a limit can be set on the maximum allowed internal distance change between pairs of adjacent data points.
A limit can be set on the maximum allowed quality value change between neighbouring groups of data points.
A threshold limit can be set on the quality value. All neighbouring groups of data points with quality values lower than the threshold can then be rejected. Indeed, the original groups of data points from the providing step can be required to meet the threshold limit.

Preferably, the method includes a further step of displaying the grown surface primitives, e.g. by redisplaying the geological object with the grown surface primitive included thereon.

Further optional features of the invention are set out below.

### BRIEF DESCRIPTION OF THE DRAWINGS

Embodiments of the invention will now be described by way of example with reference to the accompanying drawings in which:

FIG. 1 is a flow chart showing stages in a first part of a methodology, which enables the creation and utilisation of search expressions for analysing geological objects;

FIG. 2 is a flow chart showing stages in further parts of the methodology;

FIG. 3 shows a seismic amplitude cross-section;

FIG. 4 shows the cross-section of FIG. 3 after translation;

FIG. 5 shows a GUI which allows a user to set up and manipulate a translator and a search expression to be used in relation to a display of a geological attribute;

FIG. 6 shows a displayed seismic amplitude cross-section translated into three value subranges (coloured red, green and blue);

FIG. 7 shows a schematic drawing of a rectangle of interest from FIG. 6, two reflectors extending across the rectangle;

FIG. 8 shows at top the translated seismic amplitude cross-section of FIG. 6, and at bottom a corresponding GUI, circles in the cross-section indicate positions which match a search expression defined in the GUI;

FIG. 9 shows the translated seismic amplitude cross-section and GUI of FIG. 6, but with the search expression defined in the GUI increased by three further entries, and a consequent decrease in matched points in the cross-section;

FIG. 10 shows the translated seismic amplitude cross-section and GUI of FIG. 9, but with an adjustment to a translator defined in the GUI, and a further consequent decrease in matched points in the cross-section;

FIG. 11 shows matched data points resulting from applying the translator and search expression of FIG. 10 across the 3D seismic volume from which the cross-section of FIGS. 6 and 8 to 10 was taken;

FIG. 12 shows (a) a seismic cross-section, and (b) the same seismic cross-section overlaid with AntTracks based on a chaos attribute;

FIG. 13 shows at bottom the translated seismic cross-section of FIG. 12(a), and at top a GUI representation of a six entry search expression that has produced matched points in the cross-section;

FIG. 14 shows at bottom the translated seismic cross-section of FIG. 12(b), and at top GUI representations of the search expression of FIG. 13 and a second search expression that has produced matched points in the cross-section;

FIG. 15 is identical to FIG. 14 except that the second search expression has been adjusted to remove matched points at fault positions;

FIG. 16 shows the matched points of FIG. 15 overlayed on the seismic cross-section of FIG. 12(a);

FIG. 17 shows schematically a workflow of an iterative approach for extracting data points;

FIG. 18 shows a seismic amplitude cross-section from a seismic input cube and demonstrates the seismic signal changing laterally along a reservoir;

FIG. 19 shows at bottom right the seismic amplitude cross-section of FIG. 18, at top a GUI defining a translator and a first iteration search expression, and at bottom left the corresponding translated seismic amplitude cross-section;

FIG. 20 is a 3D view showing, for top, mid and base reservoir surfaces, extracted data points from arrangements of data points which match the first iteration search expression of FIG. 19;

FIG. 21 shows at bottom right a further seismic amplitude cross-section from the seismic input cube of FIG. 18, at top a GUI defining a translator of a second iteration search expression, and at bottom left the corresponding translated seismic amplitude cross-section;

FIG. 22 is a 3D view showing, for the top, mid and base reservoir surfaces, the first iteration extracted data points of FIG. 20 and extracted data points from arrangements of data points which match the second iteration search expression of FIG. 21;

FIG. 23 shows at bottom right a further seismic amplitude cross-section from the seismic input cube of FIG. 18, at top a GUI defining a translator of a third iteration search expression, and at bottom left the corresponding translated seismic amplitude cross-section;

FIG. 24 is a 3D view showing, for the top, mid and base reservoir surfaces, the first iteration extracted data points of FIG. 20, the second iteration extracted data points of FIG. 22 and the extracted data points from arrangements of data points which match the third iteration search expression of FIG. 23;

FIG. 25 shows the extracted data points of the three iterations for, at top left, just the top surface, at right, just the mid surface, and, at bottom left, just the base surface;

FIG. 26 shows a flow chart for an automatic surface primitive extraction procedure;

FIG. 27 shows a seismic amplitude cross-section derived from a strongly faulted seismic input cube;

FIG. 28 shows the seismic amplitude cross-section of FIG. 27 with (a) ten positions used to generate a search expression, and (b) circles identifying data points from lines matching the search expression;

FIG. 29 is a 3D view showing extracted data points from lines of data points matching the search expression of FIG. 28;

FIG. 30 shows surface primitives grown from the extracted data points of FIG. 30 using the automatic surface primitive extraction procedure; and

FIG. 31 shows at top left a surface primitive grown from the extracted top reservoir surface data points of FIG. 25, at right a surface primitive grown from the extracted mid reservoir surface data points of FIG. 25, and at bottom left a surface primitive grown from the extracted base reservoir surface data points of FIG. 25 using the automatic surface primitive extraction procedure on vertical lines of data points.

### DETAILED DESCRIPTION

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

WO2011/077300 describes a process in which input data is coded, or translated, from continuous values to discrete characters. The translated data in the form of characters can then be searched using e.g. regular expressions. The use of regular expressions allows for very flexible searches, not just in the variations of the values of the data, but also in the length of sought after features, and even with respect to the existence of a smaller feature inside a larger feature.

However, a challenge with the process described in WO2011/077300 is that it can require a high level of knowledge to create a search expression that matches the characteristic pattern of a feature. Also the translation often has to be tuned, typically in combination with adjustments to the search expression, to obtain a useful result. It would be desirable to facilitate increase uptake of the process by users, such as geologists and geophysicists, who may not have particular expertise in and experience of regular expressions.

Accordingly, a methodology is provided which enables the creation and utilisation of search expressions for analysing geological objects, such as seismic cubes, using a GUI. A user can employ the technique to be able to create searches without knowledge of the underlying search technology. The methodology has several parts:
A translator allows the user to translate data points in the object from continuous values of a geological attribute to partitioned value subranges of the attribute, and then displays the object having the translated data points. A GUI can allow the user to update the translator such that changes in the translator are reflected in changes to the displayed object. In this way, features of interest in the redisplayed object can become identifiable. Typical changes are to the overall scale of the translator and/or to individual endpoints of the value subranges.
The user then selects parts of the translated data, e.g. with a GUI pointing device, and the selected data is used to form a search expression.
The GUI displays the search expression and allows the user to edit the expression manually. The expression is used to search for arrangements of data points matching the search expression.
The matched arrangements of data points are displayed, together with the data points showing the original continuously valued geological attribute or the translated data points. The search results can be updated automatically when any of the inputs are varied, e.g. when the translator or the search expression is changed in the GUI. The translator and the search expression can be stored for future use.

The geological object can be 1 D, 2D or 3D and accordingly has corresponding 1 D, 2D or 3D datasets. Examples of 1D datasets are well logs or seismic traces. Examples of 2D datasets are 2D seismic lines, any attribute derived from 2D seismic lines, and generally any image. Examples of 3D datasets are 3D seismic cubes and any attribute derived from 3D seismic cubes.

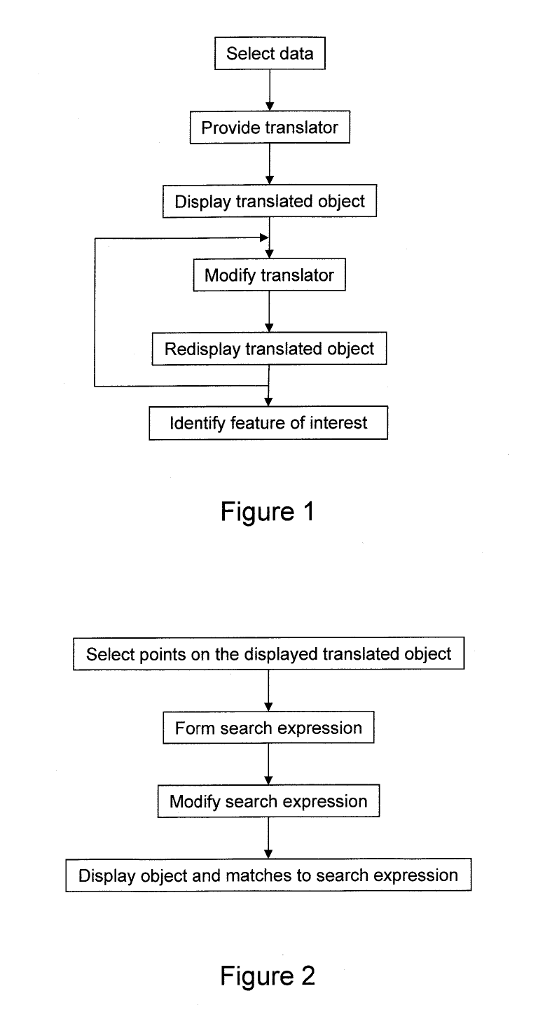

FIG. 1 is a flow chart showing stages in the first part of the methodology, and FIG. 2 is a flow chart showing stages in the second, third and fourth parts of the methodology.

By (i) automatically creating search expressions based on user input on a display of translated input data, (ii) graphical display of search expressions, and (iii) real time updating of translated input data and search results upon changes in one or more of input data, translator and search expression, users can be empowered to create, modify and use search expressions without requiring expert knowledge of them.

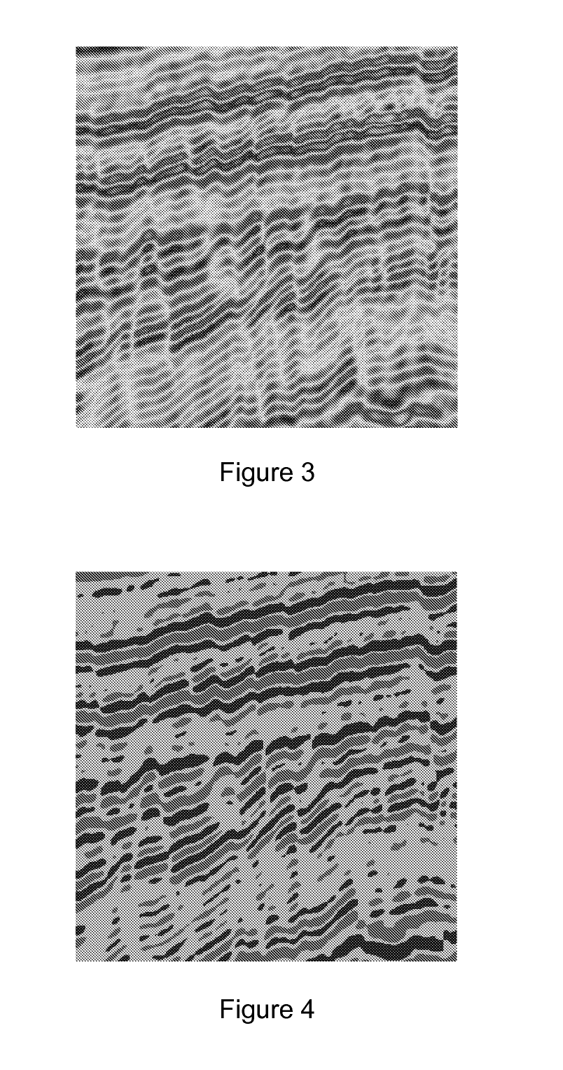

FIG. 3 shows a seismic amplitude cross-section (i.e. an example of a 2D geological object). The data points which make up the cross-section contain respective amplitude values. These values can each be allocated to one of several different value subranges. Thus, for example, if the amplitude values can be anywhere in the range of from −0.5 to +0.5, possible value subranges might be −0.5 to −0.2, −0.2-0.2, and 0.2 to 0.5. FIG. 4 shows the cross-section of FIG. 3 redisplayed with three different colours providing suitable display codings to represent the three value subranges.

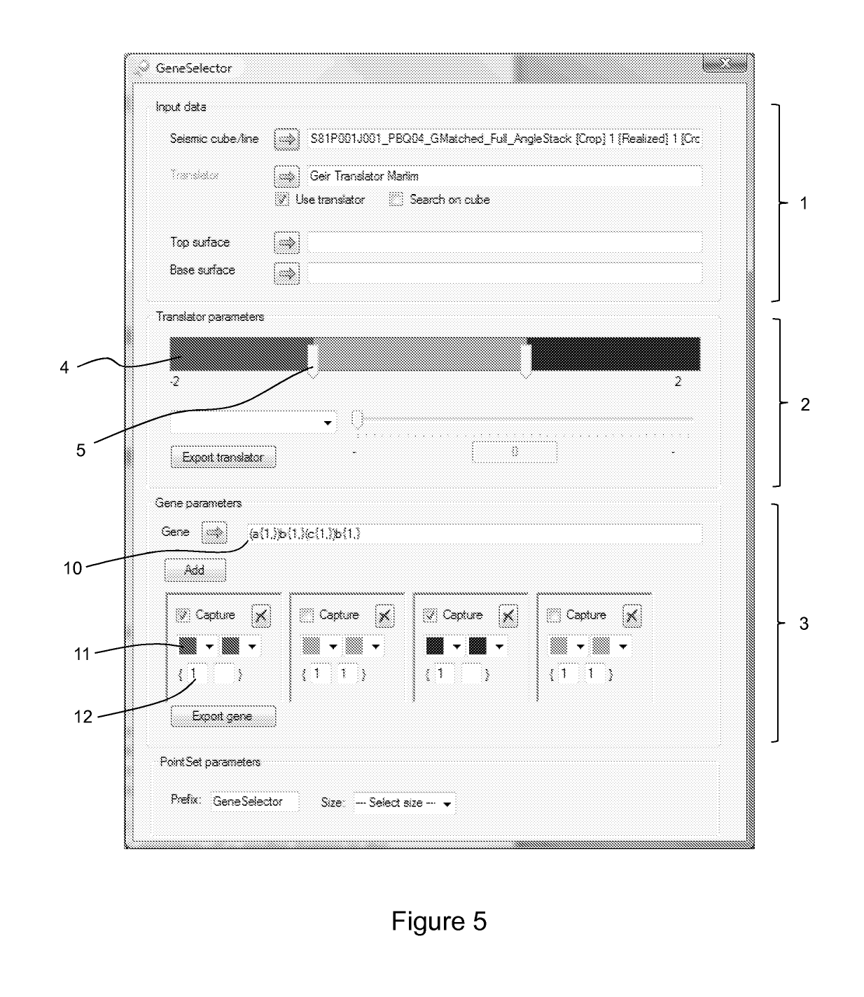

FIG. 5 shows a GUI which allows a user to set up and manipulate a translator which defines a plurality of value subranges for a geological attribute (such as seismic amplitude). The GUI has a top pane 1 with which the user specifies the input data. In a middle pane 2, a colour bar 4 displays the colours of the value subranges, with the length of each individually coloured portion of the bar representing the extent of the respective range, and the positions of the ends of each coloured portion representing the end values of the respective range. In the example shown, the translator covers a total extent of from −2 to +2. The end values and extents can be manipulated using elements such as sliders 5, or by entering end values into appropriate text entry boxes.

When the value subranges are adjusted using the middle pane 2 of the GUI, the translated cross-section is automatically redisplayed, giving the user immediate feedback on the effect of the adjustments.

By making adjusting to the translator, the user can be assisted in identifying features of interest in the redisplayed geological object. In particular, the user can then go on to define a search expression based on a feature of interest.

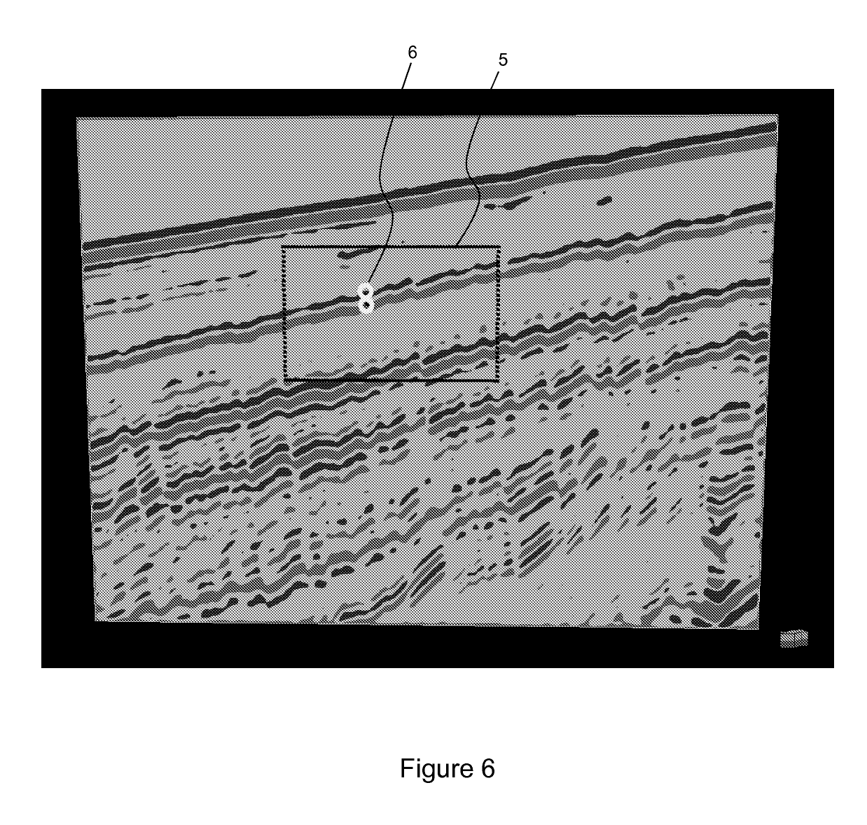

FIG. 6 shows a displayed seismic amplitude cross-section again translated into three value subranges (coloured red, green and blue). A rectangle 5 of interest is marked on the cross-section using a mouse, and two points 6 (indicated by circles) on a feature of interest within the rectangle are selected by pointing-and-clicking. The features of interest are a blue reflector followed by a red reflector. In addition there is a wide low amplitude region (green colour) above and below the two features.

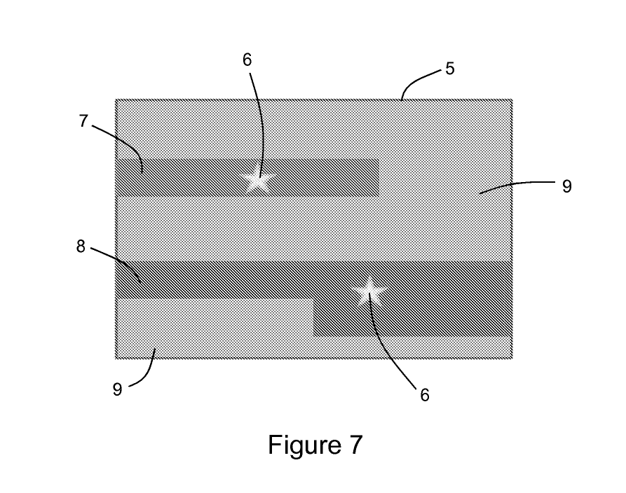

From the selected features and the selected area of interest, a search expression is generated. FIG. 7 shows a schematic drawing of the rectangle 5 of FIG. 6. Contained in the rectangle are part of a seismic line formed from the blue reflector 7 and the red reflector 8, with surrounding green regions 9 of low amplitude reflection. The selected points 6 are indicated with stars. The blue reflector 7 has a high positive seismic amplitude, is one data point thick, and disappears to the right on the seismic line. The red reflector 8, has a high negative seismic amplitude, is one data point thick at the left, and grows to two data points thick at the right.

The following algorithm can be used to determine a search expression:
1) Sort the selected points 6 from top to bottom
2) For each selected point, find the minimum and maximum vertical extents and the horizontal extent within the rectangle 5 of the connected cluster (i.e. the contiguous area of data points) with the same colour as the selected point
3) For each selected point in sorted order, and starting with the topmost selected point, create a search expression entry which includes the colour (typically in the form of a character representing the corresponding value subrange) of the selected point, and the minimum and maximum vertical extents of the corresponding connected cluster
4) If this is not the last selected point, create a further search expression entry based on the gap between the connected cluster of this selected point and the connected cluster of the next selected point. The further entry includes the colours (again typically in the form of characters representing the corresponding value subranges) of all the colours encountered in the gap between the two clusters, and the minimum and maximum vertical extents of the gap.
5) Repeat 3) and 4) with the next selected point

For example, in relation to FIG. 7 the search expression is ([a]{1,1})[b]{2,2}([c]{1,2}), where [a] represents the blue value subrange, [b] represents the green value subrange, and [c] represents the red value subrange, and the pair of numbers in the adjacent curly brackets are the corresponding minimum and maximum vertical extents. Thus, ([a]{1,1}) detects the blue reflector 7 of uniform thickness, [b]{2,2} describes the green gap between the two reflector 7, 8, ([c]{1,2}) detects the red reflector 8 of varying thickness.

The algorithm can be readily extended to 3D data by detecting the clusters in three dimensions.

Once determined, the search expression can be displayed graphically. In the GUI of FIG. 5, a four entry search expression is shown in the bottom pane 3. The search expression is displayed as a character string in text window 10. However, in addition, the value subrange(s) of each entry are displayed using the corresponding colours in drop down boxes 11, and the minimum and maximum vertical extents of each entry are also displayed in adjacent text entry boxes 12. These allow the user to easily modify the search expression.

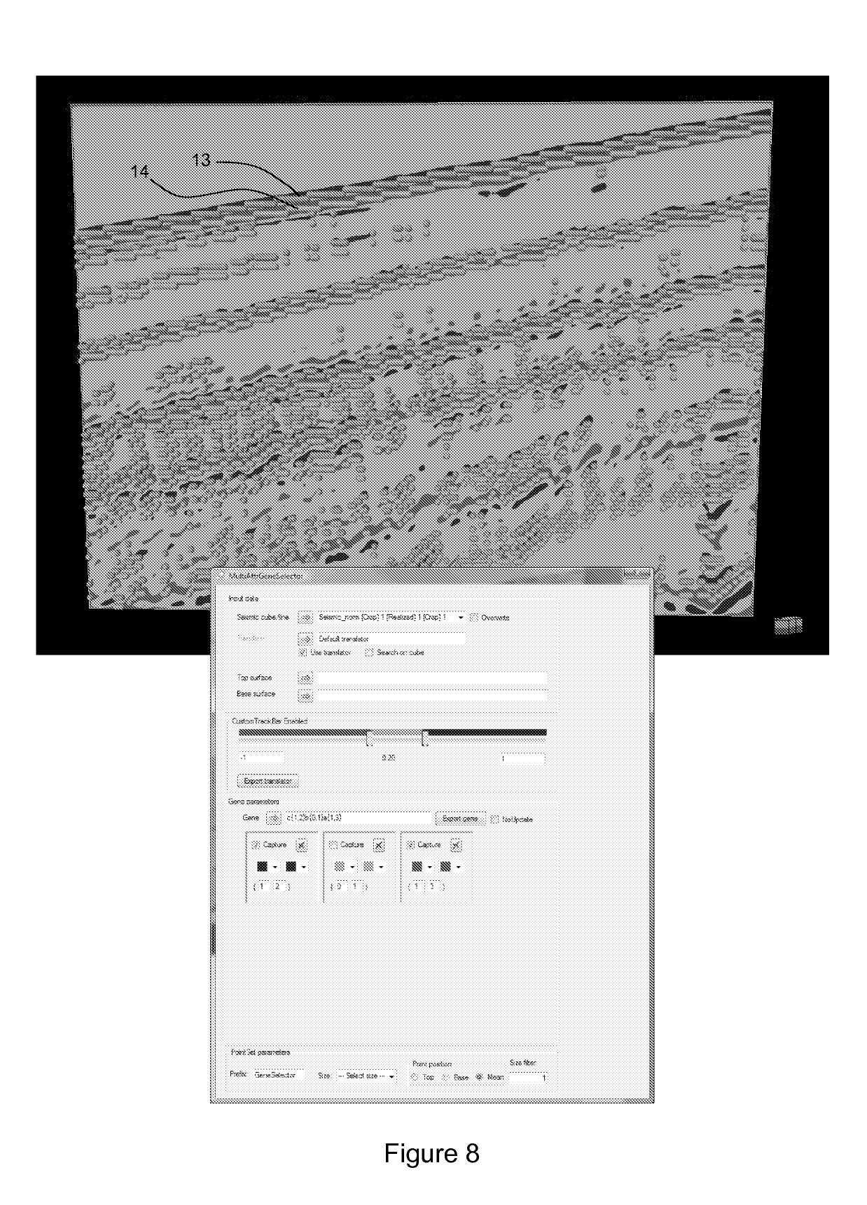

For example, FIG. 8 shows at top the translated seismic amplitude cross-section of FIG. 6. Overlayed on the cross-section are orange circles 13 showing data points matched to the first selected point and green circles 14 showing data points matched to the second selected point. There are matched points all over the cross-section, indicating that the search expression information is insufficient to properly distinguish between features of interest and other parts of the data. At bottom of FIG. 8 is the corresponding input data/translator/search expression GUI. The insufficient search expression is ([c]{1,2})[b]{0,1}([a]{1,3}). The matched points correspond to the first and third search expression entries.

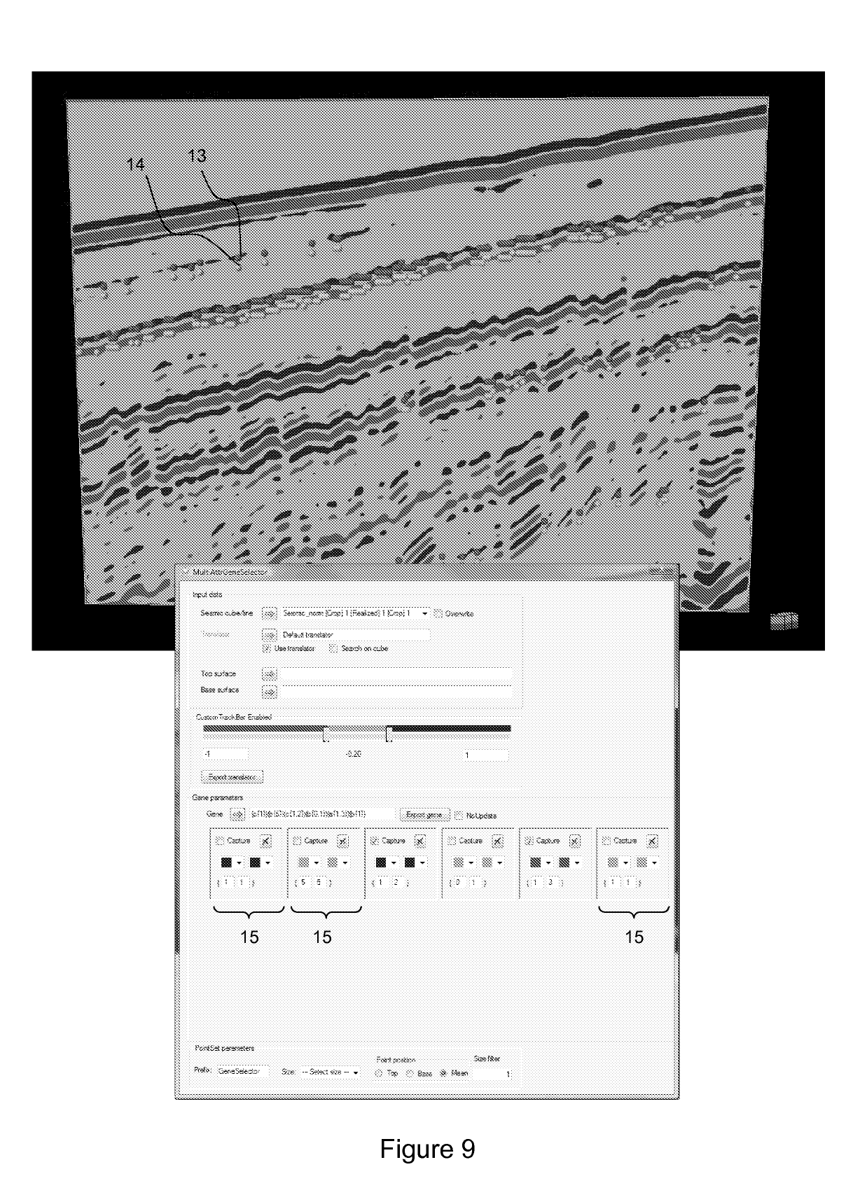

One approach to refine the search is to add entries to the search expression. FIG. 9 shows again at top the translated seismic amplitude cross-section of FIG. 6, and at bottom the corresponding GUI. However, in this case, the search expression has been increased by three further entries 15 to ([c]{1,1})[b]{5,5}([c]{1,2})[b]{0,1}([a]{1,3}[b]{1,1}). A better search result is achieved with significantly fewer matched points (now corresponding to the third and fifth search expression entries). However, a number of matches are still outside the features of interest.

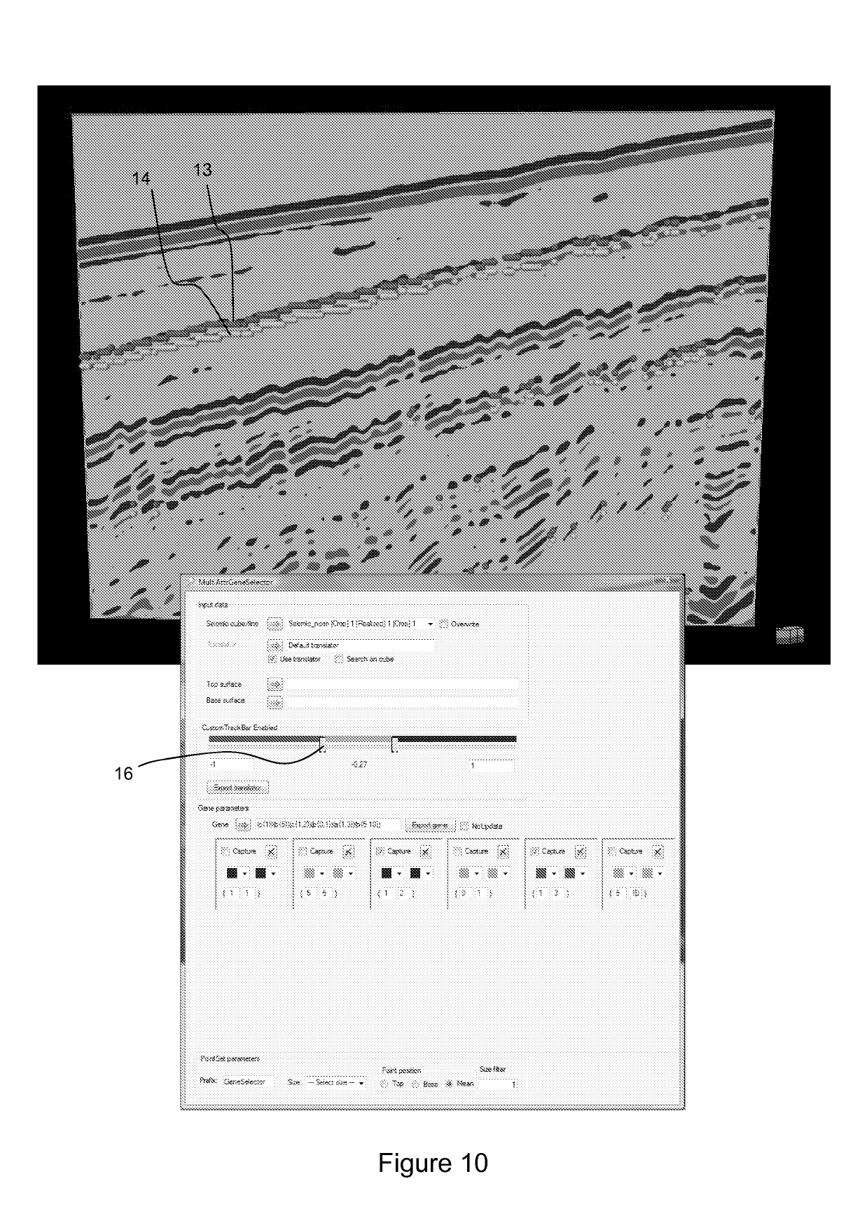

Thus another approach is to adjust the translator. FIG. 10 shows at top the translated seismic amplitude cross-section but, as shown at bottom in the corresponding GUI, the boundary 16 between the red and the green colour is moved to the left to increase the green value subrange [b] and decrease the red value subrange [a]. Now the matched points are almost exclusively restricted to features of interest.

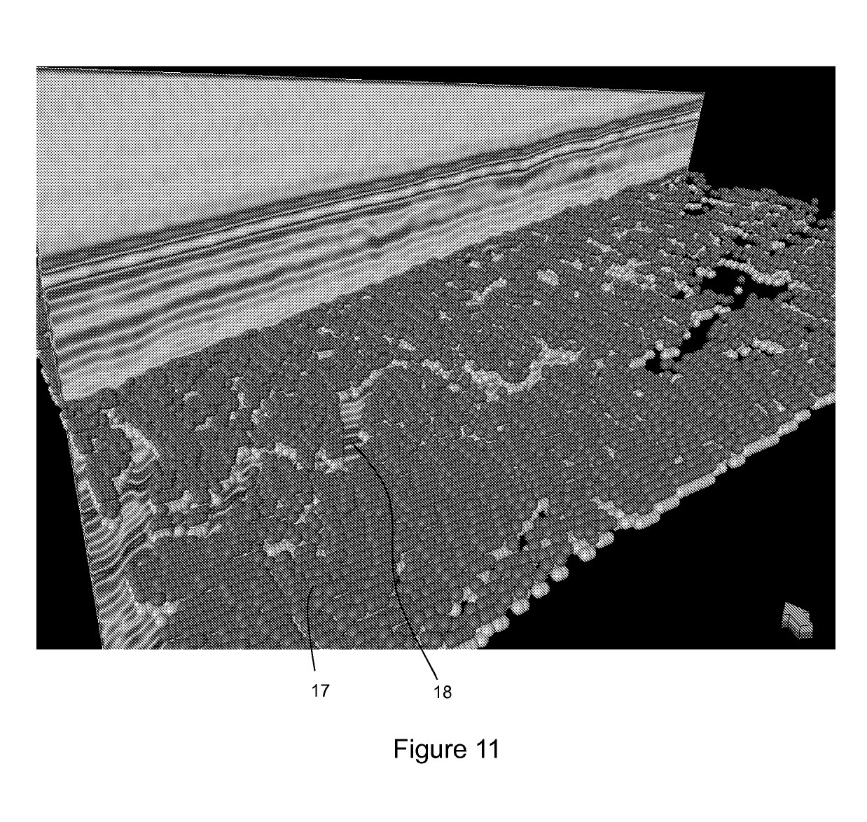

FIG. 11 shows the result of applying the translator and search expression across the 3D seismic volume from which the cross-section of FIGS. 6 and 8 to 10 was taken from. Circles again show matched data points. The search expression has extracted almost a complete surface 17, and the absent matches in that surface describe a geometric feature 18 which might be of significance.

The methodology described above can be extended to plural data sets, making it possible to create multi-attribute searches. In general, however, such data sets must be identical in extent.

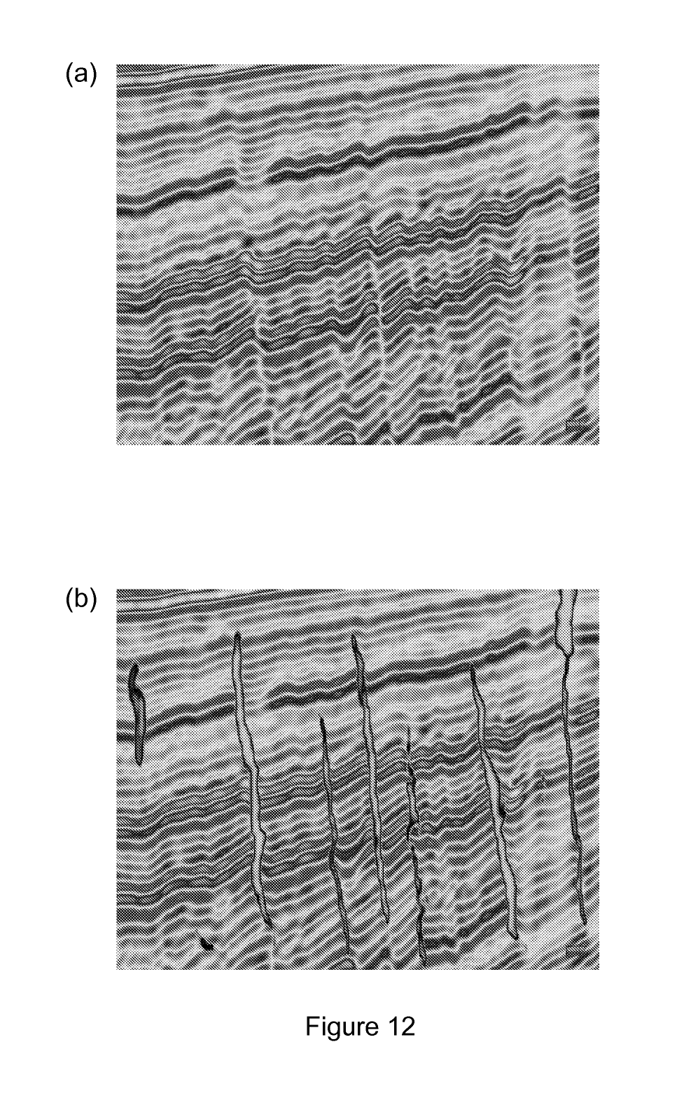

FIG. 12 shows (a) a seismic cross-section, and (b) the same seismic cross-section overlaid with AntTracks (described in U.S. Pat. No. 7,203,342) based on a chaos attribute (described in T. Randen and L. Sønneland, Atlas of 3D Seismic Attributes in Mathematical Methods and Modelling in Hydrocarbon Exploration and Production, A. Iske and T. Randen (eds.), Springer 2005, and T. Randen, E. Monsen, C. Signer, A. Abrahamsen, J. O. Hansen, T. Saether, J. Schlaf and L. Sønneland, Three-dimensional texture attribute for seismic data analysis, Expanded Abstr., Int. Mtg., Soc. Explorational Geophys., 2000). The AntTrack chaos attribute highlights seismic discontinuities such as faults.

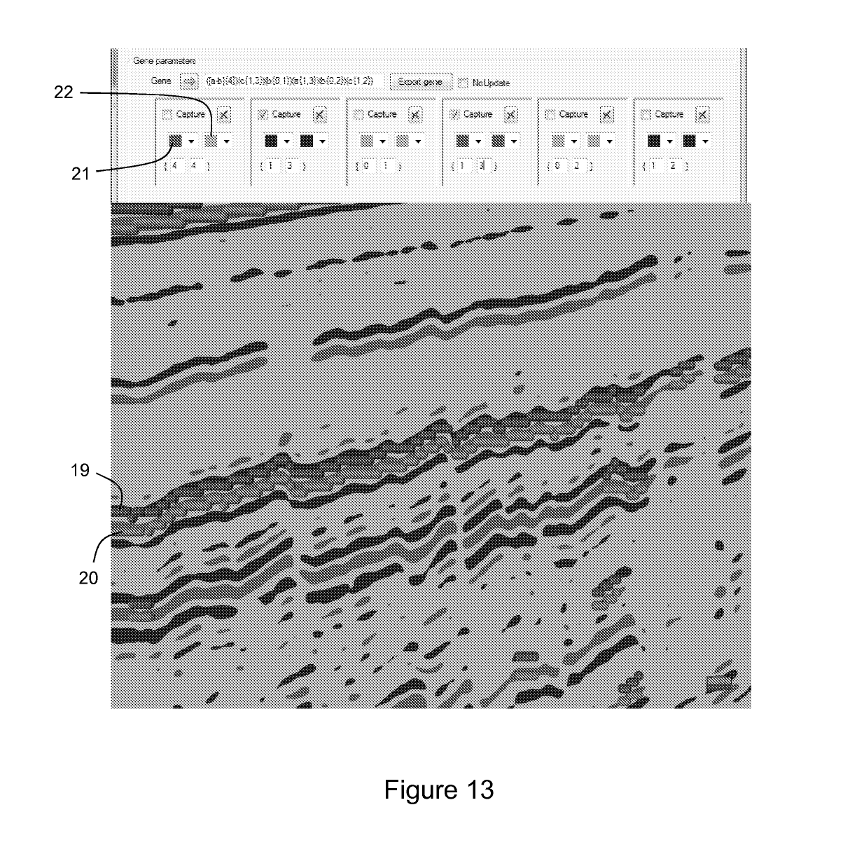

FIG. 13 shows at bottom the translated seismic cross-section of FIG. 12(a), with three value subranges represented by the colours red, green and blue. FIG. 13 also shows at top a six entry search expression that has produced the matched points indicated by circles 19, 20 in the cross-section. The matched points correspond to the second and fourth search expression entries. Note that the first entry of the search expression is ([a-b]{4,4}), where [a-b] indicates that the data points can be in the [a] or the [b] subrange (or any intermediate subrange, although in this case there are no subranges between [a] and [b]). The [a] is represented in the drop down box 21 by a red colour (for [a]), and the [b] is represented in the drop down box 22 by a green colour (for [b]).

The matched points 19, 20 follow two horizons, but it would be desirable to eliminate matches which superimpose on the faults or seismic discontinuities indicated by the AntTracks of FIG. 12(b).

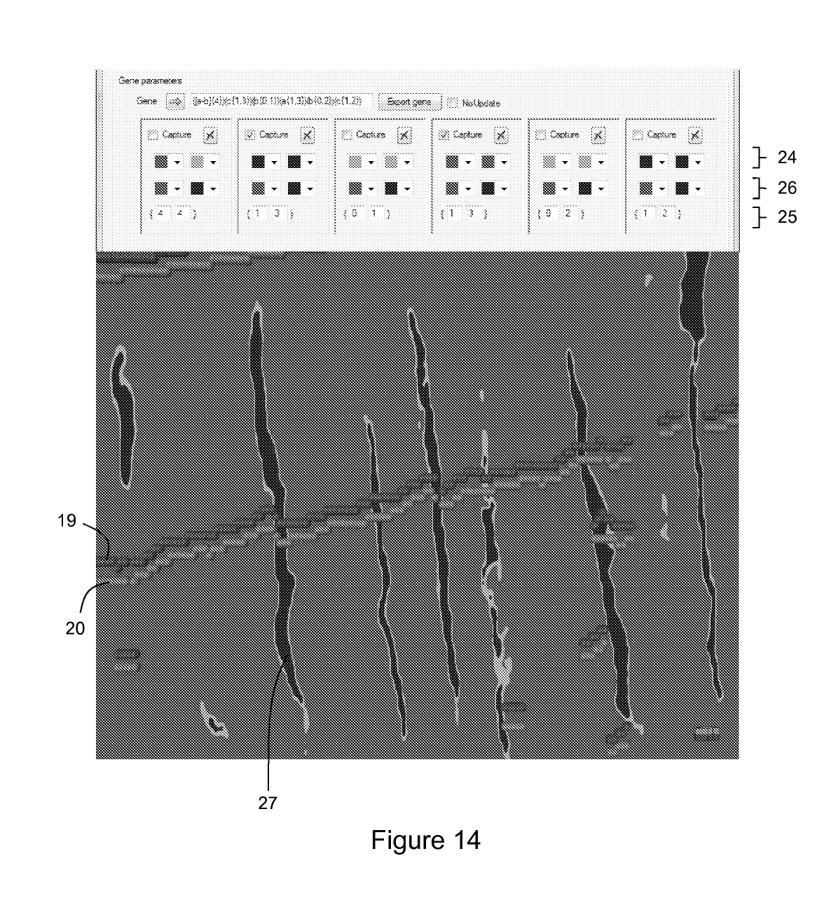

FIG. 14 shows at bottom the translated seismic cross-section of FIG. 12(b), with three (different) value subranges again represented by the colours red, green and blue. FIG. 14 also shows at top a row 24 of coloured drop down boxes which represent the value subranges of the search expression shown in FIG. 13 and a row of text entry boxes 25 which provide the minimum and maximum vertical extents of each entry of the search expression shown in FIG. 13. However, in addition, FIG. 14 also shows at top a further row 26 of coloured drop down boxes which, in combination with the row of text entry boxes 24, form a second search expression that reproduces the matched points 19, 20 in the cross-section of FIG. 14.

Thus the first search expression relates to the first attribute of FIG. 12(a) and the second search expression relates to the second attribute of FIG. 12(b). In order to provide the same matched points in FIG. 14 as appear in FIG. 13, each of the six value subranges in the further row 26 spans the whole range (which in this case that is from red through green to blue, i.e. [a-c]).

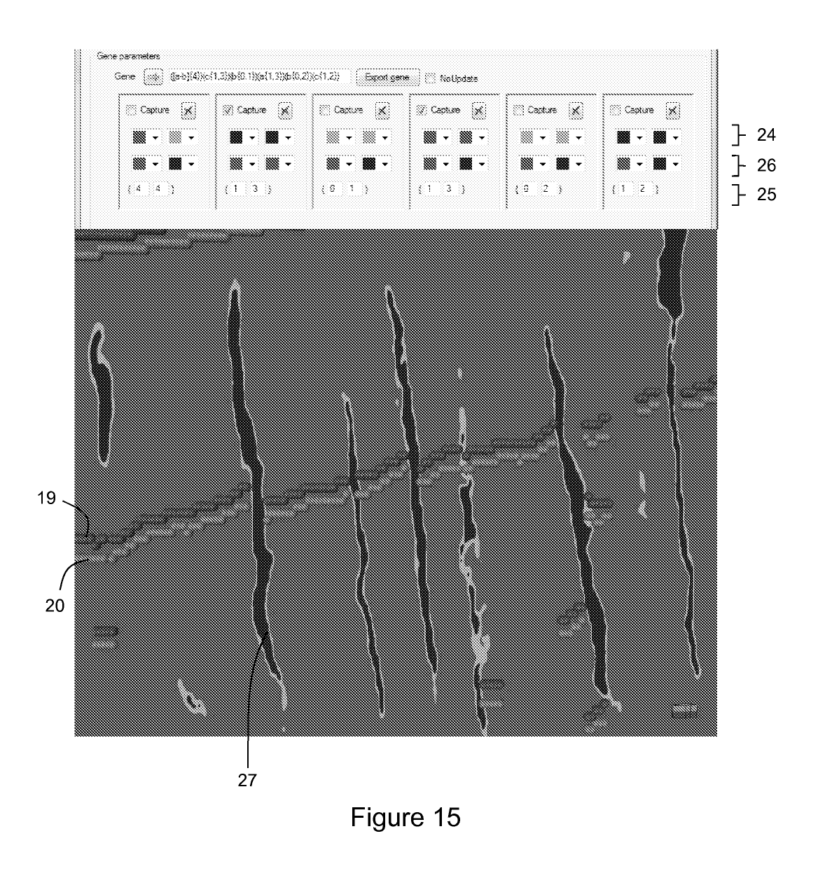

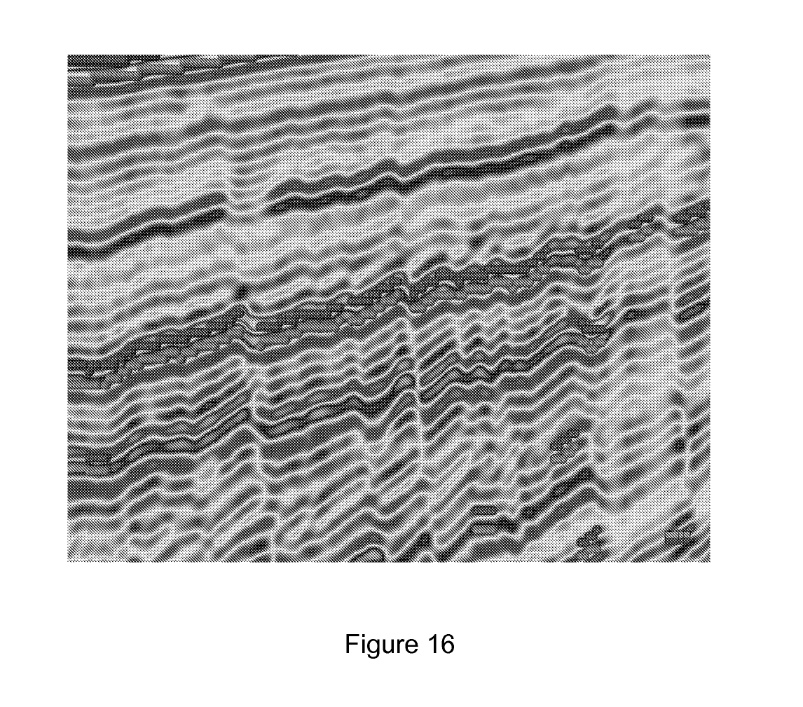

From FIG. 14, however, it is clear that the faults 27 are marked by blue and green colours. To eliminate the matches of the two horizons on the fault positions all that is needed is to change the colour range of one of the entries of the second search expression (i.e. row 26) to include only the red colour. FIG. 15 is identical to FIG. 14 except that this change has been made to the second entry of row 26, with the result that the matches at the fault positions have been removed. The new result is also shown in FIG. 16, but overlayed on the original seismic cross-section of FIG. 12(a).

The visually guided approach described above for analysing geological objects, such as seismic cubes, using translators and search expressions can be particularly beneficial for the extraction of data points in challenging data sets. For example, it can be used iteratively to build a collection of extrema sequences with different seismic signatures representing different geological features or different parts of the same geological feature.

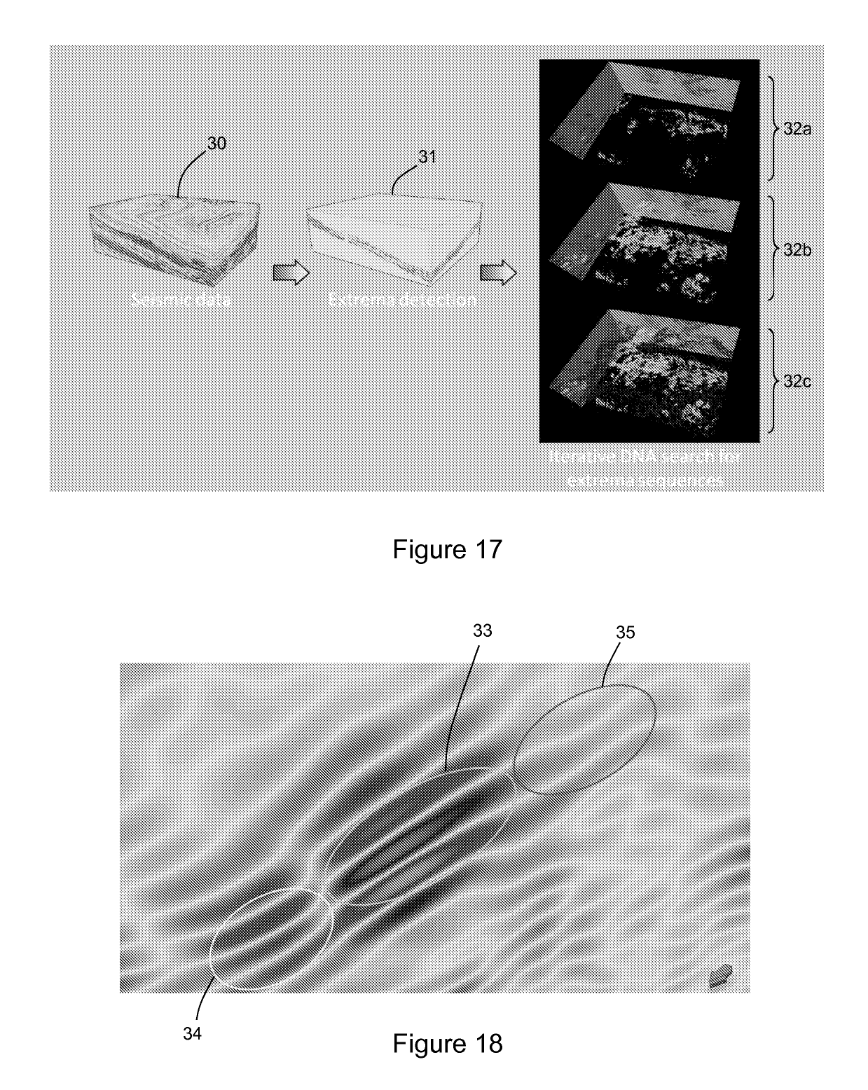

The different search expressions can be run on a regular 2D/3D seismic cube or directly on a 2D/3D extrema cube (e.g. an extrema representation of a 2D/3D seismic input volume, as described in U.S. Pat. No. 7,248,539). If necessary, other attributes can be added to the data points of the data set for operation on by the search expressions. FIG. 17 shows schematically the workflow of the iterative approach. Firstly a geological object 30, such as a 3D seismic cube 30, is provided. Optionally, this is converted into a different form, such as an extrema cube 31. Next, matched arrangements of data points 32a are identified in the object using the visually guided approach described above. This is followed by iterative adjustments to the search expression to successively identify further matched arrangements 32b, 32c of data points from regions which did not provide matched arrangements in previous iterations. In the specific example of FIG. 17, the result is an increase at each iteration in the lateral extent of a given extrema surface.

A typical implementation of the iterative approach may have the following steps:
Select a seismic cube.
Produce an extrema representation from the seismic cube and optionally one or more other attribute cubes.
Loop over the following steps as long as the user needs to extract more data points from the cube (e.g. the loop can end when visual inspection reveals that enough matches have been identified over a desired lateral extent, and around challenging zones, such as faults):
   Use the visually guided approach to adjust the search expression, and optionally the translator, taking into account which parts of the cube are already represented by arrangements of data points matched to search expressions during previous loops.
   Search the set of data points for arrangements of data points having geological attributes matching the adjusted search expression
   Add the data points extracted from the identified matched arrangements to the collection of extracted data points.
The collection of extracted data points is then typically exported for further processing.

FIGS. 18 to 25 illustrate an example of the iterative approach in relation to the extraction of extrema sequences along the top, mid and and base surfaces of a reservoir in a challenging data set.

FIG. 18 shows a seismic amplitude cross-section from the seismic input cube and demonstrates how the seismic signal changes laterally along the reservoir. Inside the circle 33 the seismic amplitude is strong and the signal has good connectivity. The strong signal represents sand regions which have high permeability. On the other hand, the seismic signal is weaker and noisier within the circle 34, and even weaker in the circle 35. The weak signal represents non-sand regions having low permeability. These three regions cannot be adequately mapped by a single search expression. Thus a solution is to split the reservoir zone into different parts and consider them individually.

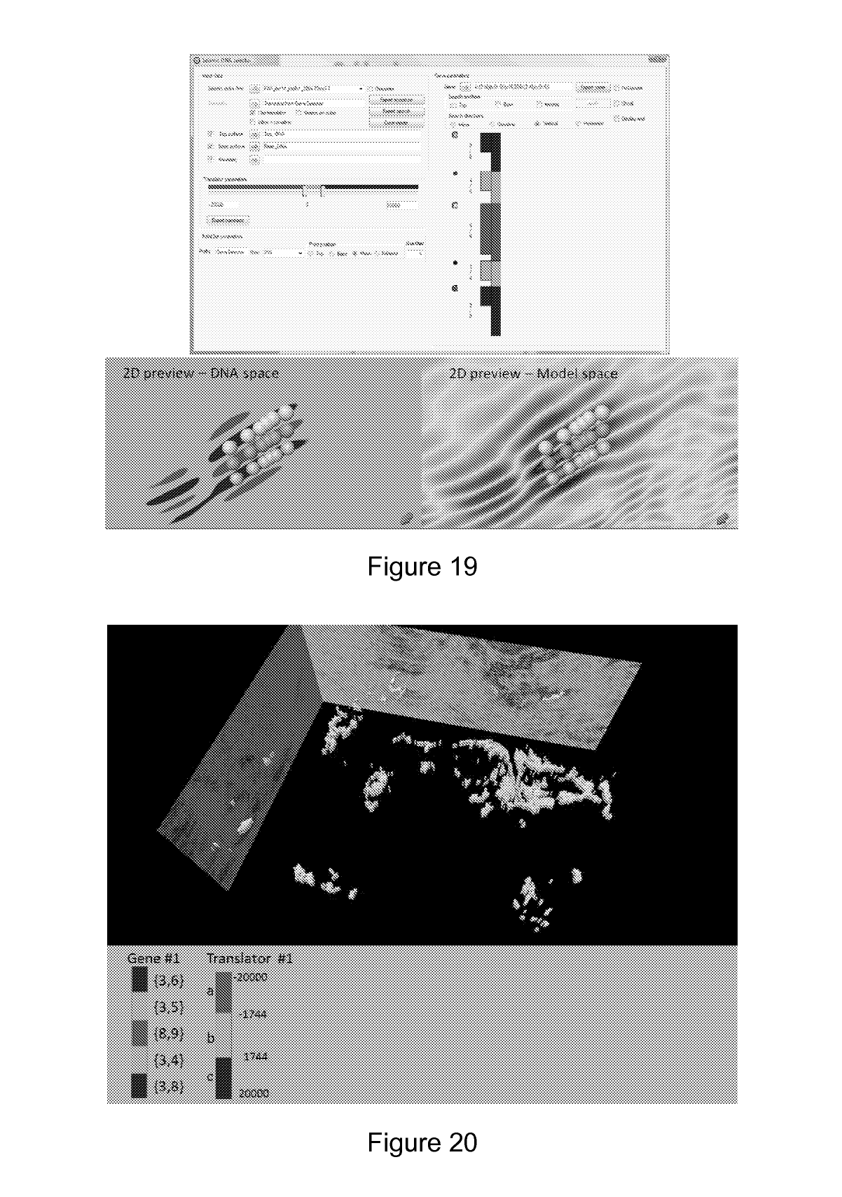

In a first iteration, all the regions which have the strongest amplitude along the reservoir are mapped. FIG. 19 shows at bottom right the seismic amplitude cross-section of FIG. 18, at top a GUI defining a translator and a search expression, and at bottom left the corresponding translated seismic amplitude cross-section. The translator splits the seismic amplitude into subranges coded by the letters a, b and c (respectively red, green and blue) and having the following value ranges:

| Letter | Value range |
|---|---|
| a | up to but not including −1744 |
| b | from −1744 up to (but not including) 1744 |
| c | 1744 and above |

The initial search is provided by the search expression: (c{3,6})(b{3,5})(a{8,9})(b{3,4})(c{3,8}), and looks for an arrangement of data points on a vertical line in which a strong positive event is followed by a strong negative event and then by another strong positive event. In the seismic amplitude and translated cross-sections of FIG. 19, the positions of extracted data points from the matched arrangements which have the strongest amplitudes on the top, mid and base surfaces are indicated by spheres. These points are limited to circle 33 of FIG. 18. The full extent of the matches, however, is better demonstrated by FIG. 20, which is a 3D view showing the extracted data points from arrangements which match the search expression. In FIG. 20, yellow coloured spheres represent the extracted data points which have strongest amplitude on the top surface of the reservoir, green coloured spheres (largely hidden by the yellow spheres) represent the extracted data points which have strongest amplitude on the mid surface of the reservoir, and pink coloured spheres (also largely hidden by the blue spheres) represent the extracted data points which have strongest amplitude on the base surface of the reservoir.

At the next iteration more matches are added to the reservoir surfaces. From the seismic data it can be observed that there are larger lateral areas with relatively good connectivity, but with weaker amplitude responses. The translator is thus changed to allow weaker amplitudes into the a and c subranges:

| Letter | Value range |
|---|---|
| a | up to but not including −907 |
| b | from −907 up to (but not including) 886 |
| c | 886 and above |

The search expression is also adjusted to (c{4,7})(b{1,4})(a{3,8})(b{1,4})(c{5,8}).

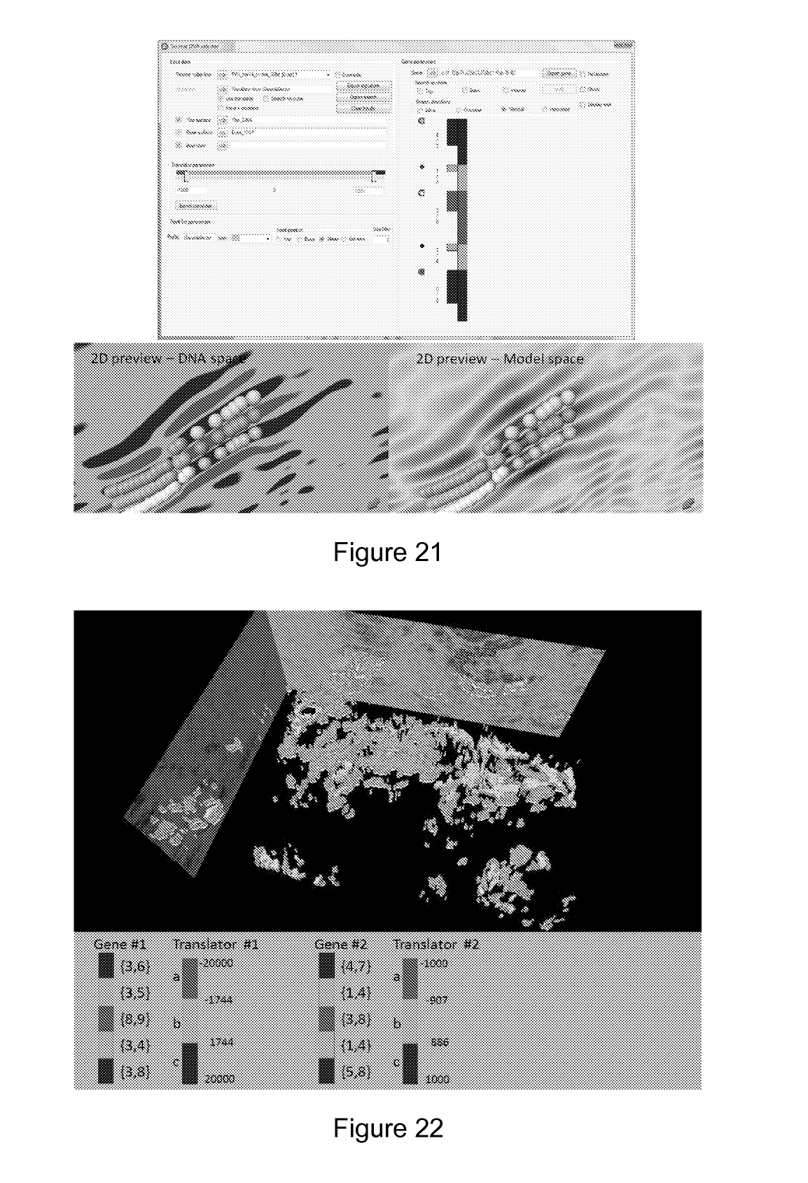

FIG. 21 shows at bottom right a seismic amplitude cross-section, at top a GUI defining the translator of the second iteration and the search expression, and at bottom left the corresponding translated seismic amplitude cross-section. The hits on the 2D cross-section now include events from circle 34 of FIG. 18 due to the adjustment of the search expression.

FIG. 22 shows the corresponding 3D view, and illustrates the increase in number of hits on the 3D view, orange coloured spheres representing the extracted data points from the newly matched arrangements which have strongest amplitude on the top surface of the reservoir, light blue coloured spheres represent the extracted data points from the newly matched arrangements which have strongest amplitude on the mid surface of the reservoir (largely hidden by the orange spheres), and white coloured spheres (also largely hidden by the orange spheres) representing the extracted data points from the newly matched arrangements which have strongest amplitude on the base surface of the reservoir. If extracted data points are situated on the same vertical line for both the first and the second iterations, then the extracted data points from the second iteration are discarded.

A large part of the lateral extent of the reservoir is covered during these two iterations. The remaining voids represent noisy and weak “tuning” zones. Generally, we define a tuning zone as a zone of weak, noisy or a strongly changing seismic signal. For example, a fault can produce a tuning zone. However, sometimes, a seismic reflector can split into several vertically spaced noisy signals for other reasons.

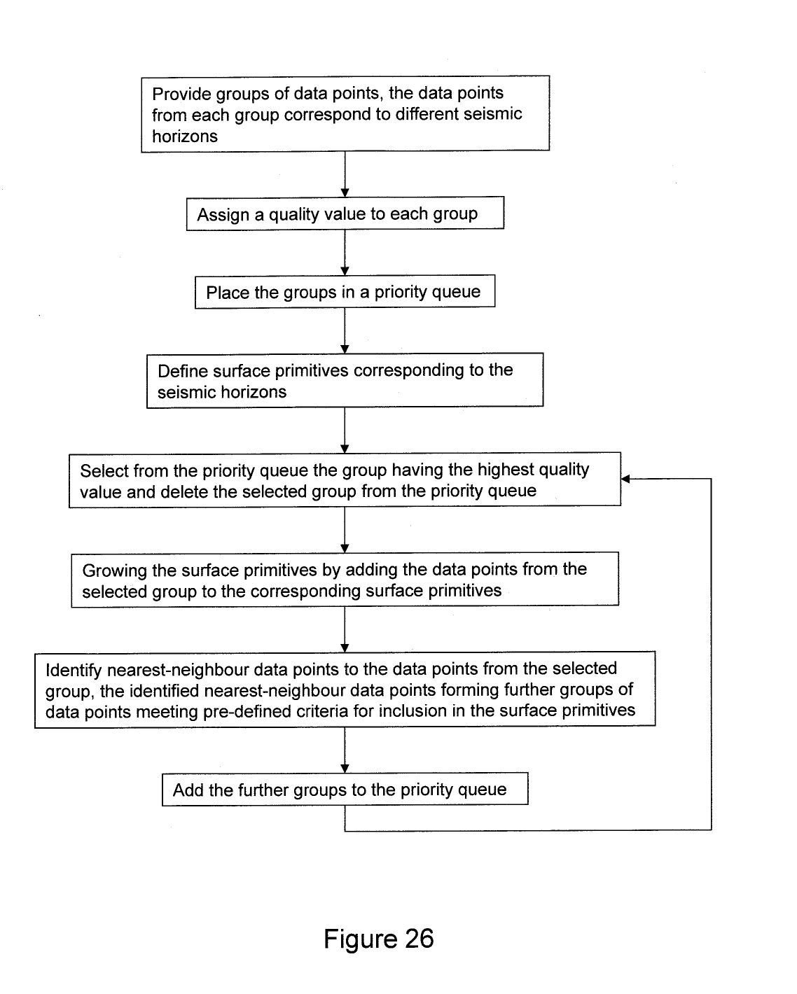

It is desirable to match data point arrangements in tuning zones, because surface interpretation tools can become unstable without explicit guidance in such zones. An advantage of the present approach is that data points can be extracted at locations corresponding to a tuning zone's upper or lower minima/maxima seismic signal. In this way, surface primitive oscillation during automated surface primitive extraction (discussed below in relation to FIGS. 26 to 31) can be avoided.

Thus a third iteration is performed. For this iteration a new translator is created:

| Letter | Value range |
|---|---|
| a | up to but not including −968 |
| b | from −968 up to (but not including) −164 |
| c | from −164 up to (but not including) 164 |
| d | from 164 up to (but not including) 972 |
| e | 972 and above |

The subranges are coded by the letters a, b, c, d and e (respectively red, green, dark blue, yellow and light blue). The search expression is adjusted to (d{4,7})(c{1,4})(b{3,8})(c{1,4})(d{5,8}).

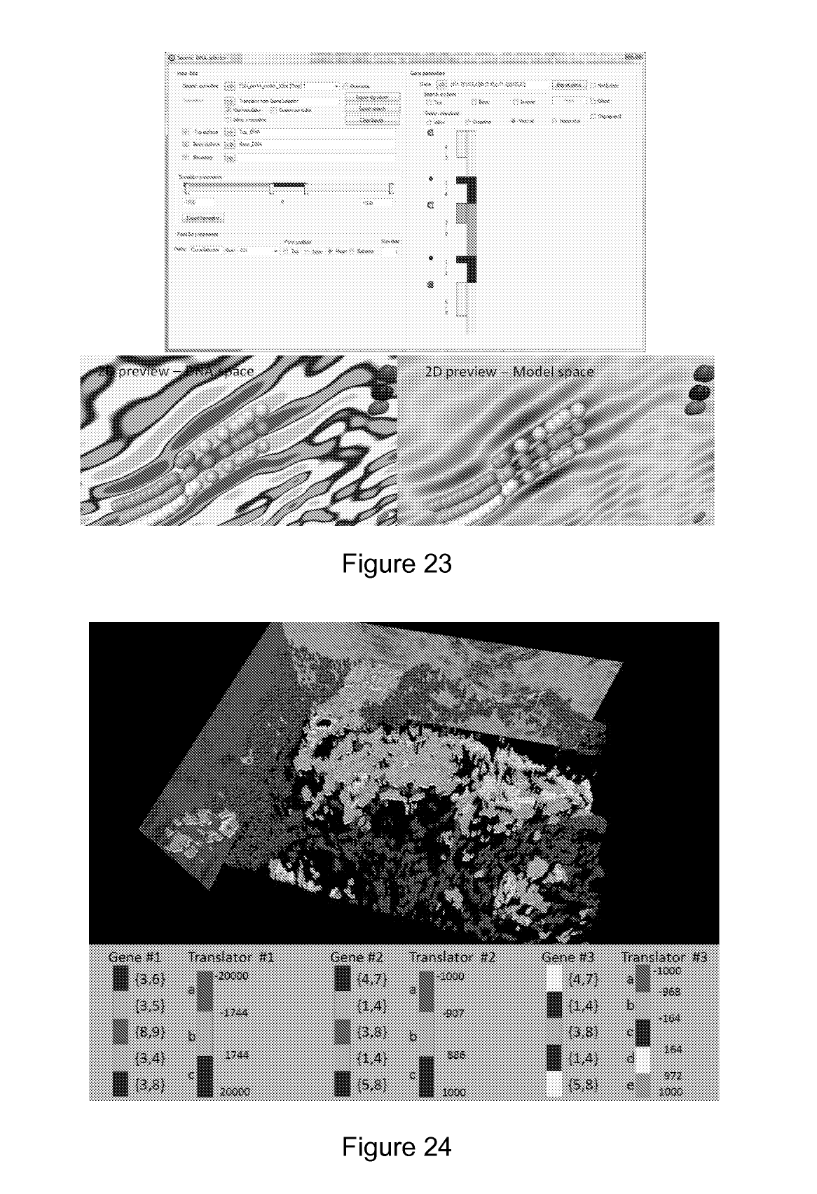

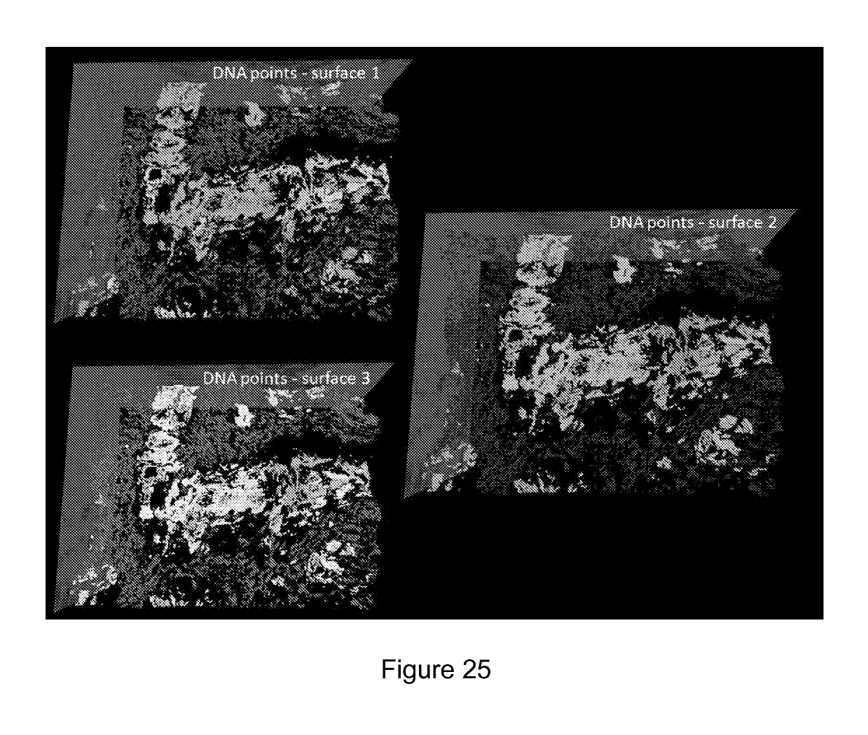

FIG. 23 shows at bottom right a seismic amplitude cross-section, at top a GUI defining the translator of the third iteration and the search expression, and at bottom left the corresponding translated seismic amplitude cross-section. FIG. 24 shows the corresponding 3D view, red coloured spheres representing the extracted data points from the newly matched arrangements which have strongest amplitude on the top surface of the reservoir, dark blue coloured spheres represent the extracted data points from the newly matched arrangements which have strongest amplitude on the mid surface of the reservoir, and violet coloured spheres representing the extracted data points from the newly matched arrangements which have strongest amplitude on the base surface of the reservoir. If extracted data points are situated on the same vertical line for one of the previous iterations and the third iteration, then the extracted data points from the third iteration are discarded. FIG. 25 shows the extracted data points of the three iterations for, at top left, just the top surface, at right, just the mid surface, and, at bottom left, just the base surface.

There are now enough data points at all three surfaces to apply a procedure to automatically extract surface primitives corresponding to these surfaces, as discussed next.

Various seismic interpretation tools conventionally are available to end users for automatic surface primitive extraction procedure. Some of them are seed point based, where the seed points are produced manually by the end user. These methods can typically extract one single surface at the time. A fully automated method, based on Bayesian classification, is described in U.S. Pat. No. 7,248,539. In this method, all extrema points within a seismic volume are grouped into different surface segments based on different waveform attributes. This tool is useful in reservoir characterization applications. However, seismic interpretation across faults and through tuning zones can still be difficult.

The present automatic surface primitive extraction procedure is an extended seed point based interpretation tool. The procedure allows extrema surfaces to be grown automatically and as large as possible, such as to reservoir boundaries and other larger reference surfaces. Further, instead of growing from single seed points along one seismic event, the procedure can consider a sequence of seismic events simultaneously. In this way, correct geological time sorting of the extracted surface primitives is possible.

Advantageously, by focusing the extraction procedure on targeted surfaces, computer memory issues can be avoided. More specifically, by extracting a fixed number of surface primitives, the lateral extent of the extracted surfaces can be increased at the expense of the vertical geological time window. This makes it possible to grow large surfaces up to basin scale.

FIG. 26 shows a flow chart for the automatic surface primitive extraction procedure. Firstly, groups of data points are provided. These can be extracted data points from the iterative data point extraction procedure discussed above, each group of data points in the surface primitive extraction procedure corresponding to one of the matched arrangements of data points from the data point extraction procedure. The extracted data points from each group correspond to different seismic horizons. A quality value is assigned to each group data points, and the groups are placed in a priority queue. Surface primitives corresponding to the seismic horizons are also defined. The procedure then repeatedly loops around the steps of: (i) selecting from the priority queue the group having the highest quality value and deleting the selected group from the priority queue, (ii) growing the surface primitives by adding the data points from the selected group to the corresponding surface primitives, (iii) identifying nearest-neighbour data points to the data points from the selected group, the identified nearest-neighbour data points forming further groups of data points meeting pre-defined criteria for inclusion in the surface primitives, and (iv) adding the identified nearest-neighbour data points to the priority queue. The loop can continue until the priority queue is empty. The grown surface primitives can then be exported and/or displayed. Effectively, the extracted data points provide constraints for the sorted growth of the surface primitives.

The surface primitive extraction procedure is particularly advantageous when applied to growth of plural surface primitives. As well as correct time ordering of the surface primitives, the pre-defined criteria for inclusion of the nearest-neighbour data points in the surface primitives can be more reliable when a number of primitives are involved.

Likewise, the quality value can be more reliable when a number of primitives are involved. However, such considerations do not exclude that the procedure can also be applied to extract a single surface primitive. In this case, however, each “group” of data points is just a single data point.

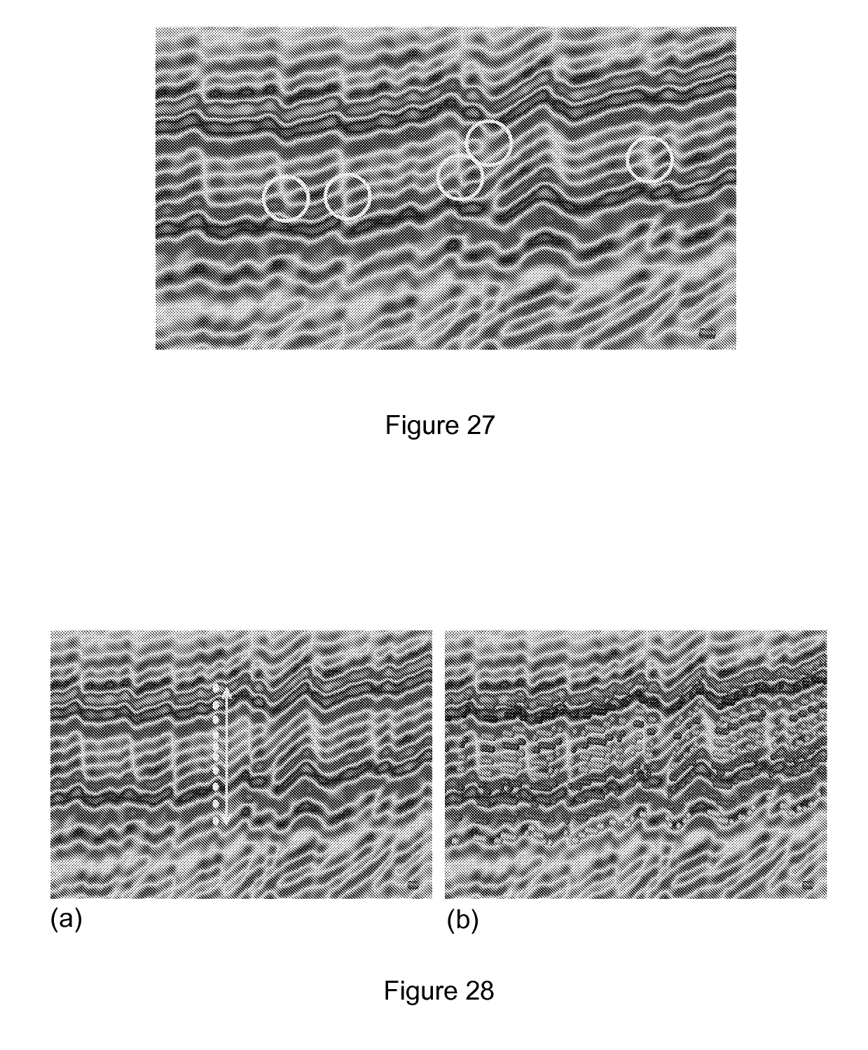

FIGS. 27 to 31 illustrate examples of the automatic surface primitive extraction procedure in relation to challenging data sets.

FIG. 27 shows a seismic amplitude cross-section derived from a strongly faulted seismic input cube. The faults make the seismic stratigraphy laterally discontinuous. Tuning effects around faults are circled. The seismic amplitude also varies between the individual seismic events. In combination, these factors represent a significant challenge to surface primitive extraction.

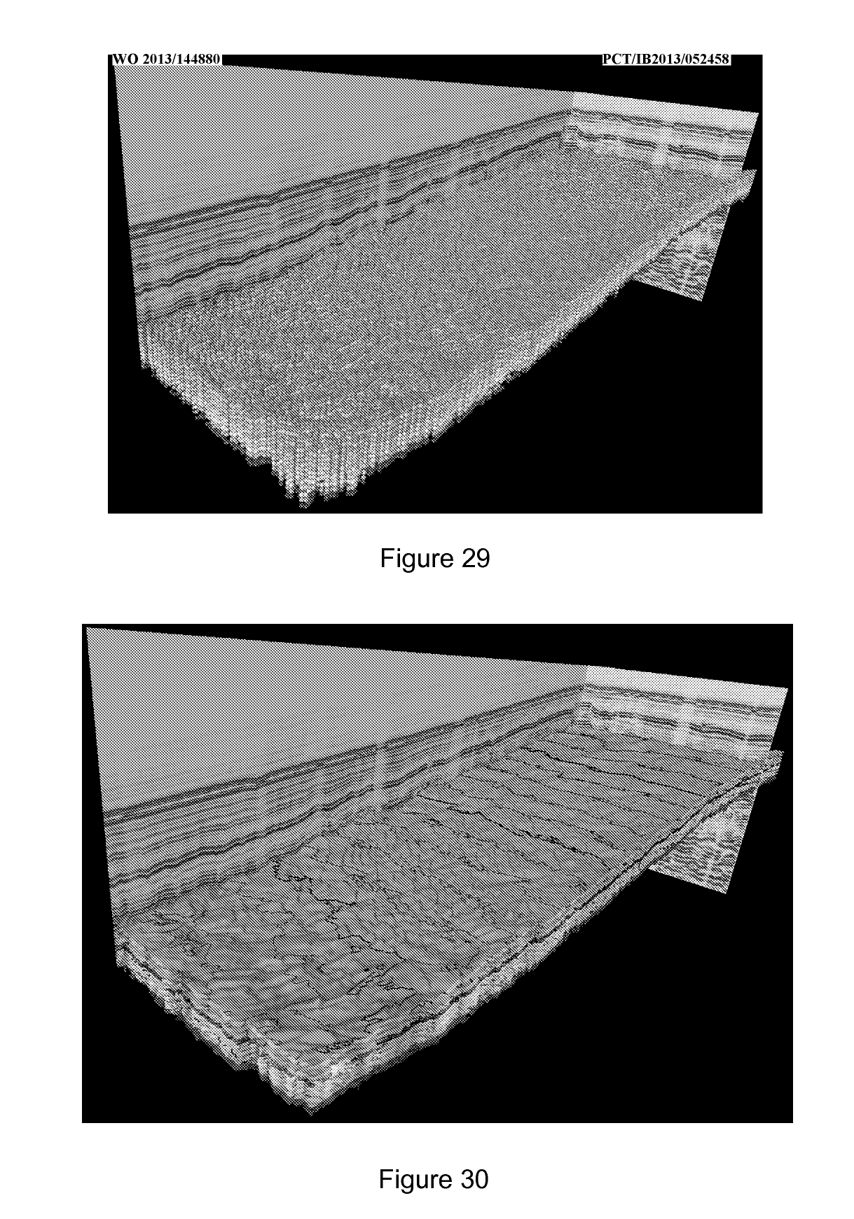

The visually guided approach described above for analysing geological objects is used to determine a search expression which corresponds to ten events of interest. A search expression for the ten events is obtained by manually clicking on the corresponding surfaces, as shown in FIG. 28(a) which is the seismic amplitude cross-section of FIG. 28 with the ten “click” positions indicated by the line of ten circles. As a preliminary test, the search expression is applied to the cross-section to look for lines of data points having geological attributes matching the search expression. FIG. 28(b) is the seismic amplitude cross-section of FIG. 27 superimposed with vertical lines of circles (ten on each line) identifying the data points of the matched lines on that section resulting from the preliminary test. The circles on each line are coloured depending on the surface event on which that circle lies. The preliminary test results suggest that the search expression is capable of identifying the events, and the expression is therefore run over the entire 3D cube. FIG. 29 shows the results of that procedure, each coloured sphere representing an extracted data point from a matched line of data points, the extracted data point again being colour coded depending on the event on which they lie.

Next, a quality value which determines the order in which the extracted data points are grown into surface primitives is assigned to each matched line of points. The quality value can consist of a combination of several different seismic attributes depending on e.g. the geometry, texture, shape, structure, etc. of the seismic data. In the present example, the seismic layering is relatively parallel and the seismic amplitude is almost constant within each seismic event. The seismic amplitude is an appropriate quality value in these circumstances, so each individual extracted point has assigned to it the corresponding seismic amplitude value. On the other hand, the seismic data are discontinuous across the faults, with significant vertical displacements, but the lines of extracted data points can guide the growth of the surface primitives across the faults.

The matched lines of extracted data points are assigned respective quality values, which are the average seismic amplitude of the ten data points of each line.

The matched lines are placed in a priority queue, with the order in the queue determined by the lines' respective quality values. Lines with high quality values are thereby considered first, and lines with low quality values (containing data points with weak amplitude and poor lateral connectivity—typically tuning and fault zones) are considered last.

Ten surface primitives are also defined corresponding to the ten seismic events of interest.

The first matched line is removed from the queue, and its ten data points are added to the respective surface primitives. The nearest-neighbour data points to these data points are identified, and allocated to corresponding vertical lines of data points. If any of these lines meet a predetermined criterion for inclusion of their data points in the surface primitives, then they are also added to the priority queue, with their positions in the queue again determined by their respective quality values. The criterion includes: (i) a requirement for the polarities of the nearest-neighbour data points to be the same as those of the data points of the matched line, (ii) a limit on the maximum vertical jump between a data point of the matched line and a corresponding data point of a neighbouring line, (iii) a limit on the maximum allowed internal distance change between pairs of adjacent data points in the matched line and a neighbouring line, (iv) a limit on the maximum allowed quality value change between the matched line and a neighbouring line, and (v) a minimum threshold limit for the quality value of a neighbouring line. In respect of (iii), if the vertical positions of the ten data points in the matched line are m₁, m₂, . . . m₁₀, then the nine vertical distances between adjacent pairs of points are (m₁−m₂), (m₂−m₃), . . . (m₉−m₁₀). Based on these distances, the maximum allowed internal distances (n₁−n₂), (n₂−n₃), . . . (n₉−n₁₀) between the corresponding ten data points of the neighbouring line (having vertical positions n₁, n₂, . . . n₁₀) are then set according to (1−C)(mᵢ−mᵢ₊₁)≦(nᵢ−nᵢ₊₁)≦(1+C)(mᵢ−mᵢ₊₁) where i=1, 2, . . . 9, and C is a number in the range from 0 to 1. Typically C is set to about 0.1.

The next line is removed from the queue, and the process repeated, until the priority queue is empty. The surface primitives are thus gradually grown by the addition of data points from the priority queue, the growth being driven at all times by the highest quality value remaining in the queue. The ten surface primitives grow in lock step as the lines of data points added to the priority queue always contain a point for each seismic horizon.

When the surface primitives have finished growing (i.e. the priority queue is empty), all the points of a given surface are laterally triangulated to convert the collection of points into a true surface for that surface primitive. Small voids or holes in each surface can be in-filled by interpolation if necessary.

FIG. 30 shows the ten complete extracted surfaces. The lines running across the surfaces are contours to indicate gradient.

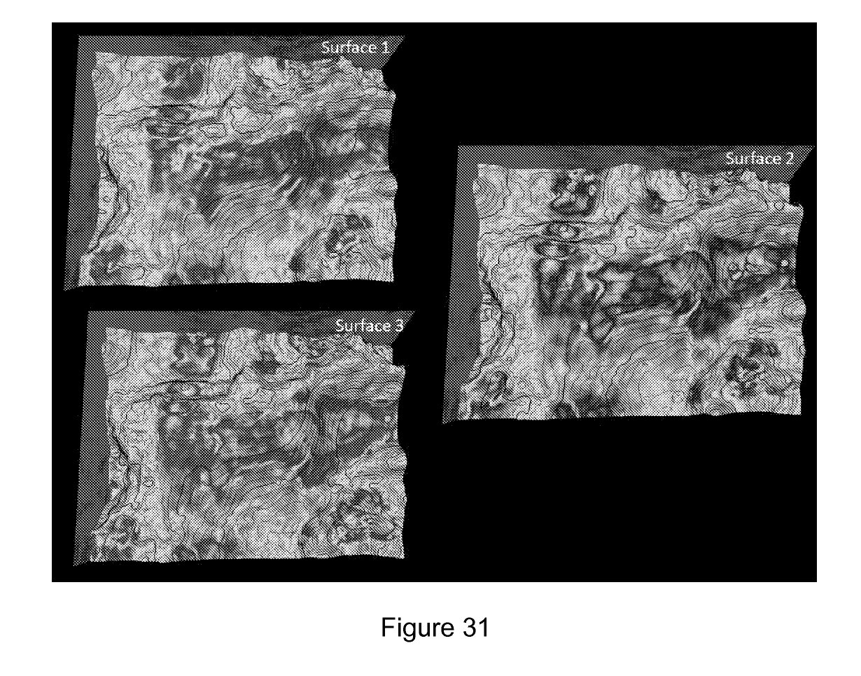

Similarly, FIG. 31 shows the result of applying the automatic surface primitive extraction procedure on vertical lines of three data points for the extracted top, mid and base surface data points shown in FIG. 25. The procedure generates continuous surface primitives for the top (top left in FIG. 31), mid (right in FIG. 31) and base (bottom left in FIG. 31).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference for all purposes.

1. A method of identifying a feature of interest in a set of data points distributed throughout a geological object, each data point containing a value for a geological attribute at that point, the method including the steps of:
providing a translator which defines a plurality of value subranges for the geological attribute;
displaying the geological object using display codings corresponding to the value subranges such that all data points which have values for the geological attribute falling within a given value subrange are displayed with the same coding;
repeatedly adjusting one or more end values of the value subranges, and redisplaying the geological object using the respective display codings for the adjusted value subranges, until the feature of interest is identifiable in the redisplayed geological object.

2. A method according to claim 1, further including the step of displaying the value subranges of the translator as translator GUI elements, and wherein the adjustment of the one or more end values of the value subranges is performed by adjusting the translator GUI elements.

3. A method according to claim 1, further including the step of determining a search expression describing the feature of interest, the search expression having a plurality of entries, wherein the determining step includes performing the steps of:
selecting a plurality of data points of the feature of interest; and
allocating value characters to entries of the search expression, the value characters corresponding to the value subranges for the geological attribute of the selected data points.

4. A computer-implemented method of determining a search expression describing a feature of interest in a set of data points distributed throughout a geological object, each data point containing a value for a geological attribute at that point, and the search expression having a plurality of entries, the method including the steps of:
displaying the geological object using display codings corresponding to value subranges for the geological attribute such that all data points which have values for the geological attribute falling within a given value subrange are displayed with the same coding;
selecting a plurality of data points of the feature of interest; and
allocating value characters to entries of the search expression, the value characters corresponding to the value subranges for the geological attribute of the selected data points.

5. A method according to claim 3, wherein the geological object is a 1D object, and the method further includes allocating extent characters to the entries of the search expression, each extent character being associated with a respective entry and specifying the vertical extent of the continuous line of data points which share the value subrange of that entry and which include the selected data point of that entry.

6. A method according to claim 3, wherein the geological object is a 2D object, and the method further includes allocating pairs of extent characters to the entries of the search expression, each pair of extent characters being associated with a respective entry and specifying the minimum and maximum vertical extents of the contiguous area of data points which share the value subrange of that entry and which include the selected data point of that entry.

7. A method according to claim 3, wherein the geological object is a 3D object, and the method further includes allocating pairs of extent characters to the entries of the search expression, each pair of extent characters being associated with a respective entry and specifying the minimum and maximum vertical extents of the contiguous volume of data points which share the value subrange of that entry and which include the selected data point of that entry.

8. A method according to claim 3, further including the step of displaying the value characters of the search expression as search expression GUI elements using said display codings.

9. A method according to claim 3, further including modifying one or more value characters of the search expression.

10. A method according to claim 3, further including the steps of:
searching the set of data points for arrangements of data points having geological attributes matching the search expression; and
identifying matched arrangements of data points.

11. A method according to claim 10, further including the steps of:
redisplaying the geological object and indicating the positions of the matched arrangements of data points.

12. A method according to claim 10, wherein each data point also contains a value for a second geological attribute at that point, the method further including the steps of:
displaying the geological object using second display codings corresponding to second value subranges for the second geological attribute such that all data points which have values for the second geological attribute falling within a given second value subrange are displayed with the same second coding, and indicating the positions of the matched arrangements of data points; and
determining a second search expression having entries corresponding to the entries of the first search expression but having value characters which correspond to the second value subranges for the second geological attribute of the matched arrangements of data points.

13. A method according to claim 12, further including the step of displaying the value characters of the second search expression as second search expression GUI elements using said second display codings.

14. A method according to claim 12, further including the steps of:
modifying one or more value characters of the second search expression; and
redisplaying the geological object and indicating the positions of the previously matched arrangements of data points which still match the modified second search expression.

15. A method according to claim 10 wherein each data point also contains a value for one or more additional geological attributes at that point, and the or each additional geological attribute has corresponding value subranges, the method further including the step of:
determining one or more additional search expressions, the or each additional search expression having entries corresponding to the entries of the first search expression but having value characters which correspond to the value subranges for a respective one of the additional geological attributes according to the matched arrangements of data points.

16. A method of extracting data points corresponding to one or more geological features of interest, the method including the steps of:
performing the method of claim 11 such that, in the redisplayed the geological object, the indicated positions of the matched arrangements of data points are at the feature(s) of interest;
repeating one or more times the sub-steps of:
identifying likely regions of the feature(s) of interest without matched arrangements of data points thereat;
adjusting the search expression to better describe the identified likely regions;
searching the set of data points for arrangements of data points having geological attributes matching the adjusted search expression;
identifying matched arrangements of data points; and
redisplaying the geological object and indicating the positions of the previously matched arrangements of data points and the most recently matched arrangements of data points; and
extracting data points corresponding to the geological features of interest from the matched arrangements.

17. A computer-implemented method of extracting signal consistent surface primitives from a set of data points distributed throughout a geological object, the method including the steps of:
providing a plurality of groups of data points, the data points from each group respectively corresponding to one or more seismic horizons;
assigning a respective quality value to each group of data points on the basis of the data points from that group;
placing the groups of data points in a priority queue;
defining one or more surface primitives corresponding to the seismic horizons; and
repeating the sub-steps of:
selecting from the priority queue the group of data points having the highest quality value and deleting the selected group from the priority queue;
growing the surface primitives by adding the data points from the selected group to the corresponding surface primitives;
identifying nearest-neighbour data points to the data points from the selected group, the identified nearest-neighbour data points forming further groups of data points meeting a pre-defined criterion for inclusion in the surface primitives; and
adding the further groups of data points to the priority queue.

18. A method according to claim 17, wherein:
each data point contains a value or values for one or more geological attributes at that point, and, in the providing step, the data points are extracted from arrangements of data points which match one or more query character strings defining values of geological attribute(s) associated with one or more seismic horizons in the geological object, the extracted data points from each matched arrangement forming a respective group and within each group respectively corresponding to the seismic horizons.

19. A method according to claim 17, wherein the providing step includes:
performing the method of claim 10 to identify matched arrangements of data points, the search expression(s) being query character string(s), and extracting data points corresponding to the seismic horizon(s) from the identified arrangements of data points.

20. A method according to claim 17, wherein the providing step includes:
performing the method of claim 16 to extract data point corresponding to the seismic horizon(s).

21. A method of processing seismic data including the steps of:
performing seismic tests to obtain seismic data for a geological volume;
performing the method of claim 1, the set of data points being based on the seismic data or a subset of the seismic data.

22. A method of controlling a well drilling operation including the steps of:
performing the method of claim 10, to identify features of interest corresponding to the matched arrangements of data points;
determining a well trajectory which extends through the geological object taking account of the identified features of interest; and
drilling a well having the specified trajectory.

23. A method of controlling a well drilling operation including the steps of:
performing the method of claim 17, to extract surface primitives corresponding to one or more seismic horizons;
determining a well trajectory which extends through the geological object taking account of the surface primitives; and
drilling a well having the specified trajectory.

24. A computer system for performing the method claim 1.

25. A computer program product carrying a program for performing the method of claim 1.

26. A computer program for performing the method of claim 1.

27. A method according to claim 1 wherein an image and/or features of the geological object are determined.

28. The method of claim 27, wherein the image and/or features are displayed and/or processed to provide an image of the geological object and/or an interior section of the Earth.
